(19) United States
(12) Patent Application Publication
(10) Pub. No.: US 2015/0104152 A1
(43) Pub. Date: Apr. 16, 2015

(54) WIRELESSLY TRIGGERED SMART MEDIA GUIDES

(71) Applicant: IN HAND GUIDES LTD., Cork (IE)

(72) Inventors: Gerard Edward Reinhardt, Manhasset, NY (US); Trevor Winckworth, Cork (IE); Stephen Martin, Cork (IE)

(21) Appl. No.: 14/484,460

(22) Filed: Sep. 12, 2014

Related U.S. Application Data
(63) Continuation-in-part of application No. 14/208,425, filed on Mar. 13, 2014.
(60) Provisional application No. 61/781,309, filed on Mar. 14, 2013.

(51) Int. Cl. H04N 21/482

(52) U.S. Cl. CPC H04N 21/482
USPC 386/243

(57) ABSTRACT

The invention is directed to wireless systems comprising one or more beacons that each emits a triggering data packet, and one or more smart media guides which upon receipt of a triggering packet, access the indicated track of digital content that has been preloaded into memory, and play that track through a user output interface. In some embodiments, each smart media guide transmits an SMG Identifier signal that can be received, stored and analyzed for purposes of understanding user behavior. In some embodiments, a transmitted content packet is transmitted by an exognenous source (such as a beacon or server-driven transceiver), received by a smart media guide, and stored for subsequent play. Beacon-based systems can be further used to trigger such things as alarms, lights, and various mechanisms. The invention has applications in such fields as tourism, marketing, demographic analysis, health care, pet care, safety and security.

### CROSS-REFERENCE TO RELATED APPLICATIONS

This application is a continuation-in-part of U.S. patent application Ser. No. 14/208,425 filed Mar. 13, 2014 which claims priority to U.S. Patent Application Serial No. 61/781,309 filed Mar. 14, 2013, the disclosures of which are incorporated by reference herein in their entireties.

This application is related to International Application No. PCT/US2014/025850 filed Mar. 13, 2014.

### FIELD

The present invention is directed generally to apparatuses, methods, and systems of a personal media player, and more particularly, to those pertaining to wireless SMART MEDIA GUIDES. The present invention is further directed generally to apparatuses, methods and systems of BEACON-BASED SYSTEMS. The present invention is still further directed generally to apparatuses, methods and systems of FORMATTED DATA COLLECTION DEVICES.

### BACKGROUND

Portable media players (PMP) store and play digital media including audio, video and images. Popular PMPs such as iPod, iPhone, Zune, Zen, etc. usually store digitized data in reprogrammable non-volatile memories such as flash memory (e.g., iPhone uses flash memory), micro drive, hard drive (e.g., iPod uses a hard drive), and/or the like. Users of PMPs purchase and/or create content, which can be downloaded into their devices for play back.

Museums and other attractions use specialized PMPs such as audio guides to provide audio commentary about collections, galleries, exhibitions, etc. These audio guides may be made available on a rental basis and are to be returned to the provider at the conclusion of the visit. A user of such an audio guide typically enters a number on the audio guide user interface corresponding to an exhibit. The audio guide then plays the audio track corresponding to the selected exhibit.

An alternative to the rental model of providing audio commentary is the sale model in which a smart media guide (hereinafter “SMG”) is sold to the customer for her to keep, rather than rented for her to return. The rental business model has several disadvantages relative to the for-sale SMG business model. Rentals typically incur an installed capital cost of >$100,000, compared to typical starting costs of 10-20% of that figure for SMGs. Rentals require at least one or two full time employees to issue the audio guides to incoming customers, and then to receive them from leaving customers and replace them on storage racks, thus requiring a greater fixed cost for the site operator. The rental units are typically heavier and bulkier than the units for sale, thus making them less comfortable for customers to carry and use. Customers may object on health grounds to wearing earpieces and handling equipment that has been previously used by unknown numbers of customers. Finally, the fact that the customer keeps the SMG, along with any accompanying branding, and perhaps auxiliary audio content, may build value for both the museum and the customer alike.

### SUMMARY

The SMART MEDIA GUIDE according to the present invention implements a compact and portable media device using a reproduction technology that provides media reproduction. In one embodiment, the SMG may comprise a microprocessor and a memory coupled to the microprocessor. The memory may be configured to store preloaded digital content. In response to interactive inputs received from an input interface, preloaded digital content may be retrieved, processed and delivered in analog format to a user via an output interface or display.

In another embodiment, the SMG may further comprise a transceiver interface that transmits identifying information, and receives in response to the transmitted information an activation signal of transmitted content. The SMG may also comprise a switching interface that may be coupled to the transceiver interface and the memory. The switching interface may receive the activation signal, and generate a control signal in accordance with the received activation signal. The generated control signal may selectively enable access to the preloaded content stored in the memory. In a further embodiment, the SMG may comprise an input interface that may receive user provided inputs, and may control operation of the media guide in accordance with the provided inputs. In another embodiment, the SMG may comprise an output interface that may provide the access enabled content to a user.

Thus, in one embodiment (Embodiment 1), the invention is directed to a smart media guide, comprising: an SMG control unit comprising an SMG microprocessor; a first SMG memory coupled to said SMG microprocessor, said first SMG memory configured to store and allow access to original content; an SMG transceiver configured to receive a triggering data packet transmitted by a beacon, said triggering data packet comprising a track number identification subpacket; an SMG digital to analog converter; an SMG user interface comprising an SMG user control interface and an SMG user output interface; and, an SMG power supply; wherein, said smart media guide is configured, after receiving said triggering data packet, to access a track from said original content corresponding to said track number indicated in said track number identification subpacket and to play said track through said SMG user output interface.

In Embodiment 1.2, the invention is directed to a smart media guide according to Embodiment 1, further configured to transmit by said SMG transceiver an SMG Identifier, which comprises SMG identifying information.

In Embodiment 1.3, the invention is directed to the smart media guide according to Embodiment 1, further configured to receive a Disablement Signal, wherein after passage of a predetermined time period since receipt of said Disablement Signal, said smart media guide will disable access to original content. In Embodiment 1.3.4, the invention is directed to the smart media guide according to Embodiment 1.3, further configured to receive a Re-Enablement Signal, and to then enable access to original content.

In Embodiment 1.5, the invention is directed to the smart media guide according to Embodiment 1, further configured to: receive a Transmitted Content Packet comprising Transmitted Content; store said Transmitted Content in a second SMG memory; determine whether a Play Criterion is satisfied; and, if said Play Criterion is satisfied, access and play said Transmitted Content through said SMG user output interface.

In Embodiment 1.6, the invention is directed to the smart media guide according to Embodiment 1, wherein said SMG digital to analog converter is capable of processing samples of at least bits.

In Embodiment 1.7, the invention is directed to the smart media guide according to Embodiment 1, wherein said SMG transceiver is further configured to operate at a radio frequency of between about 800 and about 928 MHz.

In Embodiment 8, the invention is directed to a beacon comprising: a beacon microcontroller; a beacon transceiver; and, a beacon power supply, wherein said beacon is configured to transmit at a predetermined triggering interval a triggering data packet comprising a track number identification subpacket containing a track number of a preloaded content stored on a first SMG memory.

In Embodiment 8.9, the invention is directed to the beacon according to Embodiment 8, wherein said predetermined triggering interval is between about 0.5 and about seconds.

In Embodiment 8.10, the invention is directed to the beacon according to Embodiment 8, wherein said beacon transceiver is further configured to operate at a radio frequency of between about 800 and about 928 MHz.

In Embodiment 11, the invention is directed to a triggered content system comprising: a smart media guide comprising: an SMG control unit comprising an SMG microprocessor; a first SMG memory coupled to said SMG microprocessor, said first SMG memory configured to store and allow access to original content; an SMG transceiver configured to receive a triggering data packet transmitted by a beacon, said triggering data packet comprising a track number identification subpacket; an SMG digital to analog converter; an SMG user interface comprising an SMG user control interface and an SMG user output interface; an SMG power supply; and, a beacon according to Embodiment 8; wherein: said beacon is further configured to transmit said triggering data packet comprising a track number identification subpacket containing a track number of a preloaded content stored on said first SMG memory; and, said smart media guide is configured to receive said triggering data packet, access said track of original content from said first SMG memory and play said track through said SMG user output interface.

In Embodiment 11.12, the invention is directed to the triggered content system according to Embodiment 11, wherein said beacon transceiver and said SMG transceiver are both further configured to operate at a radio frequency of between about 800 and about 928 MHz.

In Embodiment 11.13, the invention is directed to the triggered content system according to Embodiment 11, wherein said beacon transceiver and said SMG transceiver are both further configured to operate via a broadcast technology selected from the group consisting of radio frequency, WiFi, Bluetooth, ultra-wideband and infrared.

In Embodiment 11.14, the invention is directed to the triggered content system according to Embodiment 11, wherein said SMG microprocessor and said beacon microprocessor are each independently selected from the group consisting of 16-bit RISC microcontrollers comprising a clock with frequency of up to 24 MHz and an embedded non-volatile memory of at least 16 KB.

In Embodiment 15, the invention is directed to a widely interactive system comprising: an exogenous source comprising a Broadcast Control Unit selected from the group consisting of a beacon, server, PC, laptop, smartphone, and mainframe computer, wherein said exogenous source is configured to: determine whether a Broadcast Transmission Criterion is satisfied; and, if said Broadcast Transmission Criterion is satisfied, transmit a Transmitted Content Packet, wherein said Transmitted Content Packet comprises Transmitted Content; and, the smart media guide according to claim further configured to: receive said Transmitted Content Packet; store said Transmitted Content Packet in a second SMG memory; determine whether a Play Criterion is satisfied; and, if said Play Criterion is satisfied, access and play said Transmitted Content through said SMG user output interface.

In Embodiment 15.16, the invention is directed to the widely interactive system according to Embodiment 15, wherein: said Broadcast Transmission Criterion is selected from the group consisting of receipt of a Transmit Instruction transmitted from a system manager, a predetermined chronological basis and receipt of an SMG Identifer; and, said Play Criterion is selected from the group consisting of receipt of said Transmitted Content Packet, completion of a track being played, and entry of a play command by a user through the SMG User Interface.

In Embodiment 15.17, the invention is directed to the widely interactive system according to Embodiment 15, wherein: said smart media guide is further configured to transmit an SMG Identifier comprising SMG identifying information; and, said exogenous source is further configured to receive said SMG Identifier, and to read and store said SMG identifying information.

In Embodiment 17.18, the invention is directed to the widely interactive system according to Embodiment 17, wherein said exogenous source and said SMG transceiver are both further configured to operate via a broadcast technology selected from the group consisting of radio frequency, WiFi, Bluetooth, ultra-wideband and infrared.

In Embodiment 15.19, the invention is directed to the widely interactive system according to Embodiment 15, wherein said exogenous source and said SMG transceiver are both configured to operate via a radio frequency of 868 MHz.

In Embodiment 1.20, the invention is directed to a method of broadcasting content to a user comprising: determining whether a Broadcast Transmission Criterion is satisfied; if said Broadcast Transmission Criterion is satisfied, transmitting a Transmitted Content Packet comprising content from an exogenous source; receiving said Transmitted Content Packet by a Smart Audio Guide according to Embodiment 1; storing transmitted content from said Transmitted Content Packet in said Second SMG Memory; determining whether a Play Criterion is satisfied; and, if said Play Criterion is satisfied, accessing said content from said Second SMG Memory and playing said content through said SMG User Output interface.

As used herein, the term “Smart Media Guide” (or “SMG”) shall be understood to mean a device that is capable of accessing and playing digital content stored thereon. The term “Smart Media Guide” shall be understood to include any device herein referenced as an “audio card,” “smart audio card,” “smart card,” “audio guide (“AG”), “triggering device,” or “portable media player” (“PMP”).

As used herein the term “beacon” shall be understood to mean a device that periodically transmits a triggering data packet suitable for triggering a Smart Media Guide to access and play digital content stored thereon. The term “beacon” shall be understood to include any device herein referenced as a “transponder” or “transceiver.” A Beacon may be fixed to a single location, or it may be fixed to mobile device (e.g., an automobile, train, luggage), or it may be fully portable (e.g., a handheld device, a tag).

As used herein, the term “radio” shall be understood to mean a transmitter, a receiver, or a combined transmitter/receiver.

As used herein, the term “RF” (“radio frequency”) shall be understood to mean the frequency band from about 300 to about 928 MHz. Unless otherwise stated, preferred RF bandwidths for transceiver operation are about 300 to about 348 MHz, about 387 to about 464 MHz and about 77 to about 928 MHz. More preferred frequency bands include about 315, about 433, about 868 and about 915 MHz. Certain embodiments herein are represented as being based in RF communication technology. Those of skill in the art will understand that the teachings herein extend to all the aforementioned communication technologies, as well as any others known at the time of filing of this application.

As used herein, the term “ultra-wideband” (“UWB”) will be understood to mean any form of wireless transmission whose bandwidth exceeds the lesser of 500 MHz or 20% of the arithmetic center frequency, or conforming to the standards of IEEE 802.15.4a. For example, beacon-based systems comprising UWB transceivers produced by DecaWave of Dublin, Ireland are within the scope of the present invention.

As used herein, the term “user” is a person, animal or object carrying an SMG.

As used herein, the term “exogenous source” shall be understood to mean a source of a signal that is distinct from the device itself. Nonlimiting examples of exogenous sources include a beacon, a Data Collector, a Data Gathering Facility and an SMG Messaging Facility.

As used herein, the term “content” shall be understood to mean any digital file or set of readable digital files transmitted to an SMG. Nonlimiting examples of content include a digital audio file, a file providing a command to an SMG to activate an alarm or other audio, a file providing a command to an SMG to broadcast a signal (including an SMG Identifier), and a file providing a command to an SMG to activate a light or mechanism, or to prevent an mechanism from operating. The term “original content” shall be understood to mean content that resides in memory before first activation of an SMG. “Transmitted content” shall be understood to mean content transmitted to an SMG from an exogenous source after first activation of an SMG. The term “Targeted Content Transmission” shall be understood to mean a data packet that includes the SMG identifying information from at least one SMG Identifier and transmitted content.

As used herein, the term “first SMG memory” means a discrete ROM memory device, or an allocated space in a writeable memory device used to record original content.

As used herein, the term “second SMG memory” means a writeable memory device used to store transmitted content which device is distinct from an ROM memory device, or an allocated space in a writeable memory device, which space is distinct from space allocated to store original content.

As used herein, the term “SMG identifying information” shall be understood to mean information that identifies an SMG either by group or uniquely. Examples of a SMG identifying information include a device serial number, a production batch number, model number, a revision number, a location identifier, a payment identifier, a language identifier and/or the like. The term “SMG identifying information” is interchangeable with the term “tag ID.” The SMG Identifier signal contains SMG identifying information.

As used herein, the term “system manager” shall be understood to mean a device, such as a PC, laptop, smartphone, server, mainframe or other controller-based hardware, or a person through an interface. The system manager provides instructions to an exogenous source.

As used herein, the term “RSSI” means received signal strength indication, in accordance with the IEEE 802.11 protocol. RSSI is an indication of the power level being received by an antenna.

As used herein, terms for hardware components preceded by “SMG” refer to that hardware component as deployed in an SMG. Similarly, terms for hardware components preceded by “beacon” refer to that hardware component as deployed in a beacon. Thus, the term “SMG microcontroller” means the microcontroller deployed in an SMG.

### BRIEF DESCRIPTION OF THE DRAWINGS

The accompanying drawings illustrate various non-limiting examples and inventive aspects in accordance with the present disclosure:

FIG. 1 is a block diagram illustrating an overview of the components in an embodiment of the SMG;

FIG. 2 is a block diagram illustrating audio card components in an embodiment of the SMG;

FIG. 3 is a block diagram illustrating smart audio card components in an embodiment of the SMG;

FIG. 4 is a data flow diagram illustrating communication among smart audio card and peripheral components in an embodiment of the SMG;

FIGS. 5 and 6 are logic flow diagrams illustrating smart card e-ticketing in an embodiment of the SMG;

FIG. 7 is a block diagram illustrating smart card e-ticketing in an embodiment of the SMG;

FIG. 8 is a block diagram illustrating an embodiment of a uni-directional beacon-triggered system;

FIGS. 9A, 9B and 9C are diagrams illustrating slide activation in an embodiment of the SMG;

FIG. 10 is a block diagram illustrating embodiments of the SMG controller;

FIG. 11 is a block diagram illustrating embodiments of a managed Beacon system;

FIG. 12 is a block diagram illustrating an embodiment of a Beacon;

FIG. 13 is a block diagram illustrating an embodiment of a Beacon Manager;

FIG. 14 is an illustration of an embodiment of a Remote Manual Configurator;

FIG. 15 is a block diagram illustrating an embodiment of a user interface of a Remote Manual Configurator;

FIG. 16 is an illustration of an embodiment of a Managed Beacon System, and Map of Prominence;

FIG. 17 is an illustration of an embodiment of a logic diagram for interactions among a Beacon, a Beacon Manager, a Remote Manual Configurator, an IR Body Counter and a Server;

FIG. 18 is an illustration of an embodiment of a logic diagram for the interactions among the Beacon, the SMG and the SMG's output to the client.

FIG. 19 is an illustration of an embodiment of a logic diagram for interactions between the Beacon and SMG;

FIG. 20 is an illustration of an embodiment of SMG mechanical packaging and controls;

FIG. 21 is an illustration of embodiments of distance-criterion Pet Management Systems;

FIG. 22 is a block diagram illustrating an embodiment of a system for SMG Disablement/Re-Enablement;

FIG. 23 is a block diagram illustrating an embodiment of a SMG data collection system; and,

FIG. 24 is a block diagram illustrating an embodiment of a widely-interactive SMG-beacon system.

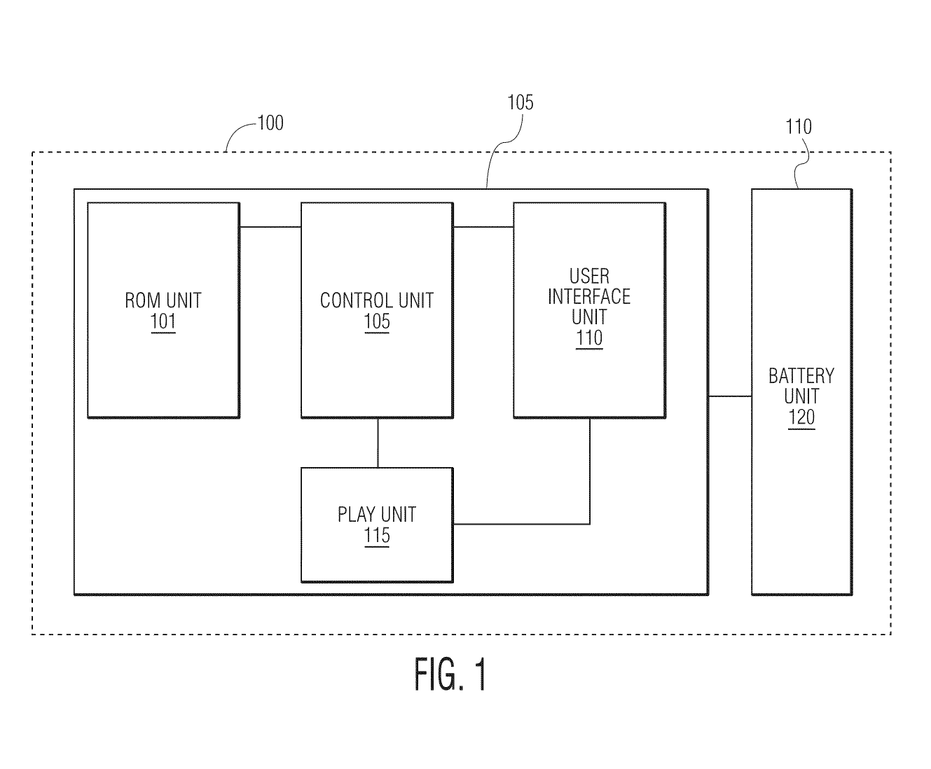

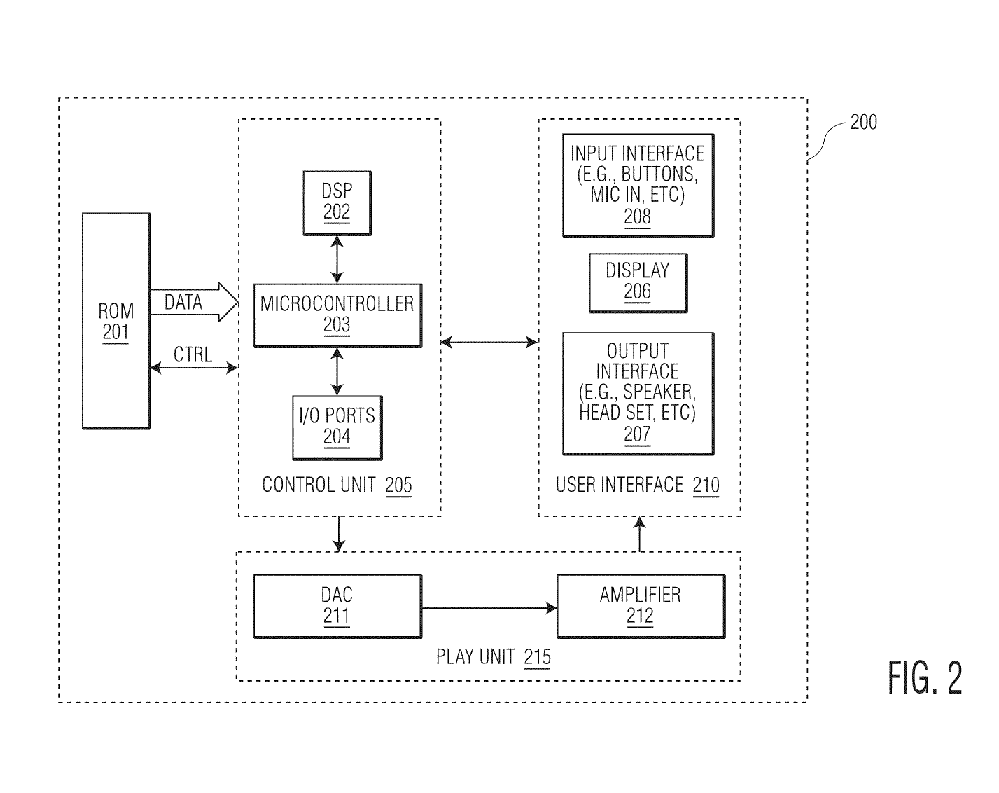

The leading number of each reference number within the drawings indicates the figure in which that reference number is introduced and/or detailed. As such, a detailed discussion of reference number 101 would be found and/or introduced in FIG. 1. Thus, reference number 201 is introduced in FIG. 2, etc.

### DETAILED DESCRIPTION

A Smart Media Guide (or “SMG”) is a device on which is stored digital content, and which is capable of accessing and playing such digital content upon either receipt of instruction to do so. Such instruction may originate from a user command through a user interface. In some embodiments, such instructions may originate from some exterior source, such as a beacon. In some embodiments, the play command originate solely through the user interface. In other embodiments, the play command originates solely through exterior source. In yet other embodiments, the play command can originate from either the user interface or an exterior source. Digital content to be stored on the SMG may be digital audio content (typically divided into tracks), an instruction to initiate an audio alarm, an instruction to initiate vibration and/or a flashing light, or an instruction to broadcast a signal. SMGs may find applications as convenient tools for providing a tour, managing admissions to tour sites, delivering site- and/or time- specific information to users, maintaining security, maintaining safety, and tracking people, pets and things, and locating objects as will be described below.

### SMG Card Components

FIG. 1 is a block diagram illustrating an embodiment of an SMG. An SMG may comprise a media card unit 105 and a power source unit 110 enclosed in an SMG housing 100. The media card unit comprises a ROM unit 101, a control unit 105, a user interface unit no and a play unit 115. The ROM unit 101 is a non-volatile memory that may not be erased or reprogrammed by a consumer. In an alternate embodiment, a reprogrammable non-volatile memory having a disabled write line may be may be used instead of the ROM unit 101. The ROM unit 101 is accessed by the control unit 105, which in turn is configured to communicate with the user interface 110 and the play unit 115. The control unit 105 includes a microprocessor and coordinates receiving and sending of control signals and data exchanges. The user interface 110 is an interface dedicated to receiving user inputs and/or triggers and outputting processed data and/or messages to the user. The play unit 115 processes and prepares data for output. The power source unit no may include a battery housing for batteries such as Lithium ion, Nickel metal hydride, lead acid, etc. and/or a power regulator circuit to protect circuit components from any current surges. In an alternate embodiment, the power source unit no may comprise photo-voltaic cells that provide power for the operation of the audio card.

The SMG microprocessor is preferably a 16-bit RISC microcontroller comprising a clock with frequency of up to 24 MHz and an embedded 16 KB non-volatile memory. The SMG ROM memory unit is preferably selected from those with capacities of from about 32 Mbit to about 128 Mbit.

FIG. 2 is a block diagram illustrating media card components in an embodiment of the SMG. The media card 200 as described above comprises a memory unit ROM 201, a control unit 205, a user interface unit 210 and a play unit 215. In one embodiment, the control unit 205 may be configured to receive user inputs via an input interface 208. The term “first SMG memory” includes memory devices such as ROM memory devices. The input interface may comprise control functions such as play/pause, stop, fast forward/skip, reverse, volume up, volume down, and/or the like. In one embodiment, the input interface may include other control functions such as mode, shuffle/random play, equalizer, bass/treble, display on/off, speaker on/off, and/or the like. In another embodiment, the input interface 208 may include microphone in (e.g., for voice commands). The input interface may be implemented using membrane switches, buttons, touch screen, etc.

The control unit 205 may be configured to communicate with a display 206. In one embodiment, the display 206 may be optional. The display 206 may display information related to content being played, status of the player, album/track title, track length/track length remaining, and/or other information that may or may not be content related but may be of use to a user (e.g., temperature, time, points of interest, etc.). The display 206 may be a liquid crystal display (LCD), inorganic or organic light emitting diode (LED or OLED) displays, and/or the like. In one embodiment, selection of the display and information to be displayed may depend on specific applications. For example, for applications requiring long battery life, a low power LCD display may be preferable. Similarly, for an SMG that has a large number of stored tracks, a display to show the track titles currently playing or tracks that are available for selection may be more useful to a user.

The control unit 205 is coupled to the memory unit ROM 201. In one embodiment, any non-volatile memory capable of storing content may be used. In such memories, the reprogrammable feature may be disabled by appropriate signal to the write line. Content may be written to the ROM 201 during production and thereafter only read access of such content may be possible. In one embodiment, the ROM 201 may be a ROM integrated with the microcontroller 203 and/or the digital signal processor DSP 202. In one implementation, the ROM 201 may be self-contained in a single chip microcontroller and may not be plugged in or pulled out (e.g., the ROM chip may be sealed). In an alternate implementation, a slot for memory may be easily accessible to the user. The user may then plug in memory cards (e.g., SD card, miniSD card, CompactFlash, Memory Stick, MultiMediaCard, SmartMedia, and/or the like).

The control unit 205 accesses the appropriate memory bank in ROM 201 to read associated content stored therein. In one implementation, the stored content may be in compressed form, having been compressed using audio/video compression schemes. For example, audio compression schemes include FLAC, WV, MPEG-4, MP3, AAC, and/or the like. Video compression schemes include MPEG, JPEG, DivX, and/or the like. The degree of compression, the amount of fidelity desired upon decompression and/or the computational resources required to decompress data may determine how much content may be stored in a memory of a given size. In an alternate implementation, the stored content may be in uncompressed format.

In one embodiment, the control unit 205 may comprise a microcontroller 203 and a digital signal processor (DSP) 202 along with input/output (I/O) ports 204. In another embodiment, a specialized DSP 202 component may be optional as microcontroller 203 may be able to perform the functions of DSP 202 (e.g., decompressing audio files). In yet another embodiment, the DSP 202 may be able to perform the functions of the microcontroller 203, making the microcontroller 203 redundant. Implementations of one or the other may depend on the controller architecture design choice and/or complexity of the decompression/digital data processing algorith

The content that is retrieved and/or decompressed by the microcontroll 203 and/or DSP 202 may be provided to the play unit 215 for further processing. The play unit may comprise a digital-to-analog converter (DAC) 211 and an amplifier 212. In one embodiment, the amplifier may be integrated with the DAC 211. The DAC may convert the uncompressed digital content to analog content and amplify the content before passing it along to the user interface 210. Preferably, the DAC is selected from those capable of processing samples of at least 16 bits.

The amplified analog content may be received by the output interface 207. The output interface 210 may in one embodiment include a headset jack to which a removable headset or other sound producing elements (e.g., speakers) may be connected. Audio content may be delivered to a user via the headset attached to the headset jack. In one implementation, the headset may be integral with the SMG. In another embodiment, the output interface may include a speaker via which audio content may be delivered to a user and/or a group of users. In yet another embodiment, the amplified content may be delivered to a user via the display 206 (e.g., video) or a message corresponding to the content may be delivered to the use.

In one embodiment, the content retrieved from the memory may be digitally driven to the output interface. In such a case, a digital-to-analog converter (DAC) 211 may not be necessary. The digital bit stream representing the content may be passed through an array of buffer elements to produce appropriate delays. The appropriately delayed bit stream may then cause the cone of the speaker to move inwards or outwards by a small increment producing an audible sound. For example, a series of zeroes in the bit stream may cause the speaker cone to move progressively inwards, while a series of ones in the bit stream may cause the speaker cone to move in the opposite direction. In this way, by directly driving the speaker with the digital content the analog sound may be reproduced.

In some embodiments, the ground shielding of the headset cable is used an antenna.

### E-Ticketing Enabled SMG

In one embodiment, smart card technology may be integrated with the SMG to impart e-ticketing capabilities to the SMG. For example, while visiting museums, attraction sites, buses, conference centers, and/or the like, visitors may purchase prepaid SMGs and use the prepaid SMGs to gain access to one or more sites. At the same time, for visitors who gain access to a site, a corresponding site-specific media guide stored in their SMGs may be unlocked or downloaded to the SMG. In this way, the cost of the media guide may be incorporated into the e-ticket, while encouraging visitors to get more out of their visits.

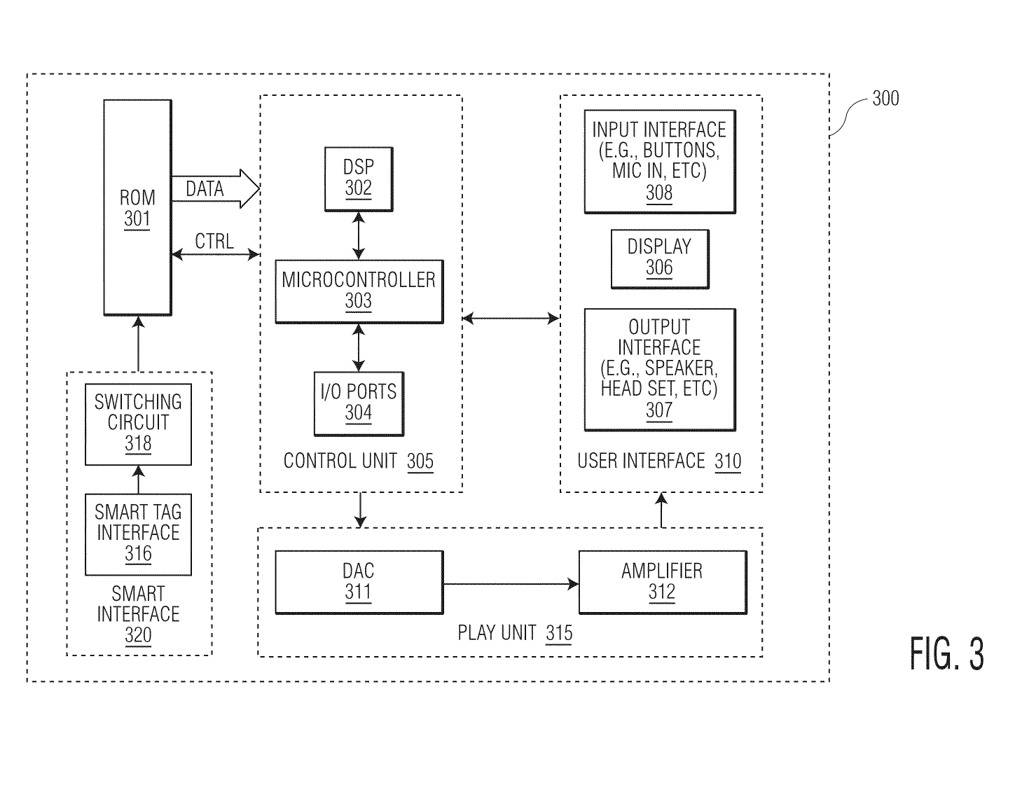

FIG. 3 is a block diagram that illustrates components of a smart audio card in an e-ticketing enabled embodiment of the SMG. Although the specification discusses smart audio cards, use of video and any other media is contemplated. As described in FIG. 2 above, the smart audio card 300 may include ROM 301, control unit 305, user interface unit 310 and play unit 315. In addition, the smart audio card 300 may include a smart interface 320, which may further comprise a smart tag interface 316 and a switching circuit 318. The smart interface 320 may be directly coupled to the ROM 301. In one embodiment, the switching circuit may be integrated with the control unit 305. The smart interface may then communicate with the ROM 301 indirectly via the control unit 305.

The smart tag interface 316, for example, in one implementation, may be a contactless smart card, for example a card having an embedded Radio Frequency Identification (RFID) chip that receives and/or transmits information to a reader without having to establish a physical contact (e.g., a swiping action). When an SMG device containing the contactless smart card is brought in the proximity of a contactless card reader, using Radio Frequency (RF) induction, the contactless smart card is powered. In one implementation, the smart card may be powered on board power supply that supplies power to other components of the smart card. The smart card may then transmit its tag ID to the card reader and may receive a control signal to authorize one or more audio tracks via the switching circuit. The tag ID in one implementation may be an identifier uniquely associated with the SMG. Examples of a unique identifier may include a device identifier, a location identifier, a payment identifier, a language identifier and/or the like.

The switching circuit, based on the control signal, may identify appropriate memory bank in the ROM 301 for activation. In one implementation, the switching circuit may be a logic circuit that generates bits corresponding to a memory bank location and read access. The logic circuit may in one implementation for example comprise logic elements such as multiplexers and encoders/decoders. In another implementation, the logic circuit may be a software code stored in a memory, which may be executed in response to receiving a trigger (e.g., an interrupt) from the smart tag interface. Selectively enabling or disabling memory banks allows the SMG to provide user access to one or more free and/or previously authorized audio tracks, while controlling user access to tracks that are not paid for.

The smart tag interface, in another implementation, may include a Subscriber Identity Module (SIM) card. A SIM card is identified by a unique identification number associated with an issuer of the SIM card, a user account and in some cases a check digit. In one implementation, the SIM card may be transferable between SMGs. For example, a SIM card in an SMG for London may be used in an SMG for Barcelona. In this way, identification and payment systems for SMGs operating in many different areas may be unified.

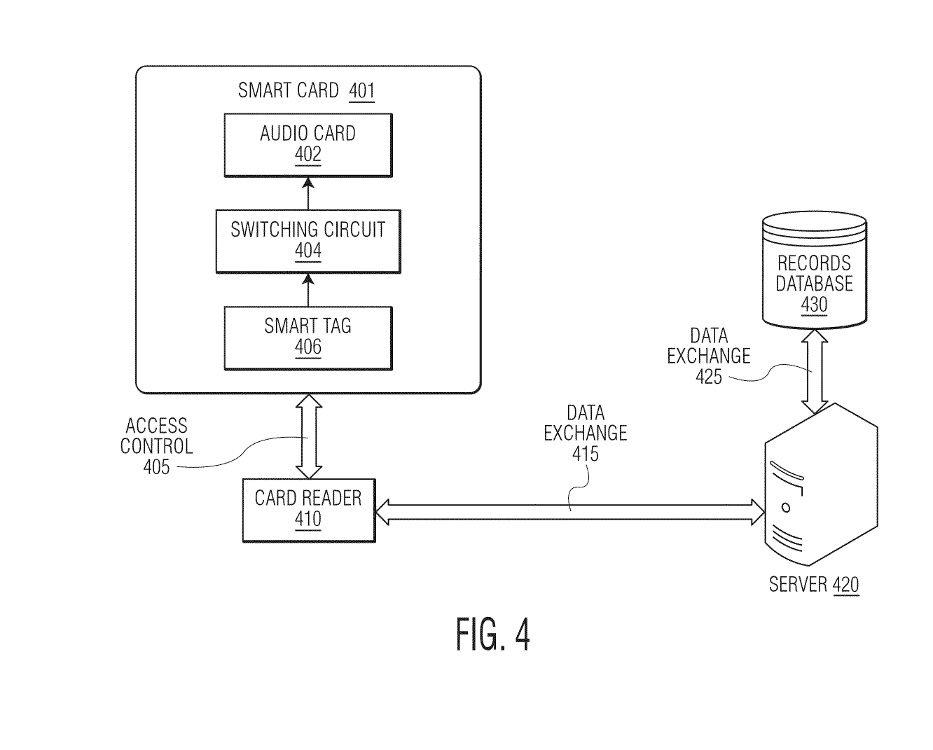

FIG. 4 is a data flow diagram that illustrates a smart card and associated components in an embodiment of the SMG. The smart card 401 in one embodiment comprises an audio card 402, a switching circuit 404 and a smart tag 406. Access to the smart card 401 may be established via a card reader 410. In one implementation, the smart card 401 may communicate with the card reader 410 via radio frequency communication protocols. In another implementation, communication may be possible by means of UWB or Bluetooth protocol, or physical connection (e.g., a conductive contact pad on the smart card makes an electrical connection with the reader). The Radio Frequency (RF), UWB, Bluetooth or other wireless links or the physical connectivity may facilitate exchange of access control and/or data 405 between the smart card 401 and the card reader 410. The card reader 410 may be in communication with a server 420 via a communication network. The communication network may facilitate data exchange 415 between the card reader 410 and the server 420. The server 420 may in turn be coupled to a database 430. The database 430 may store purchase records in association with device tag IDs.

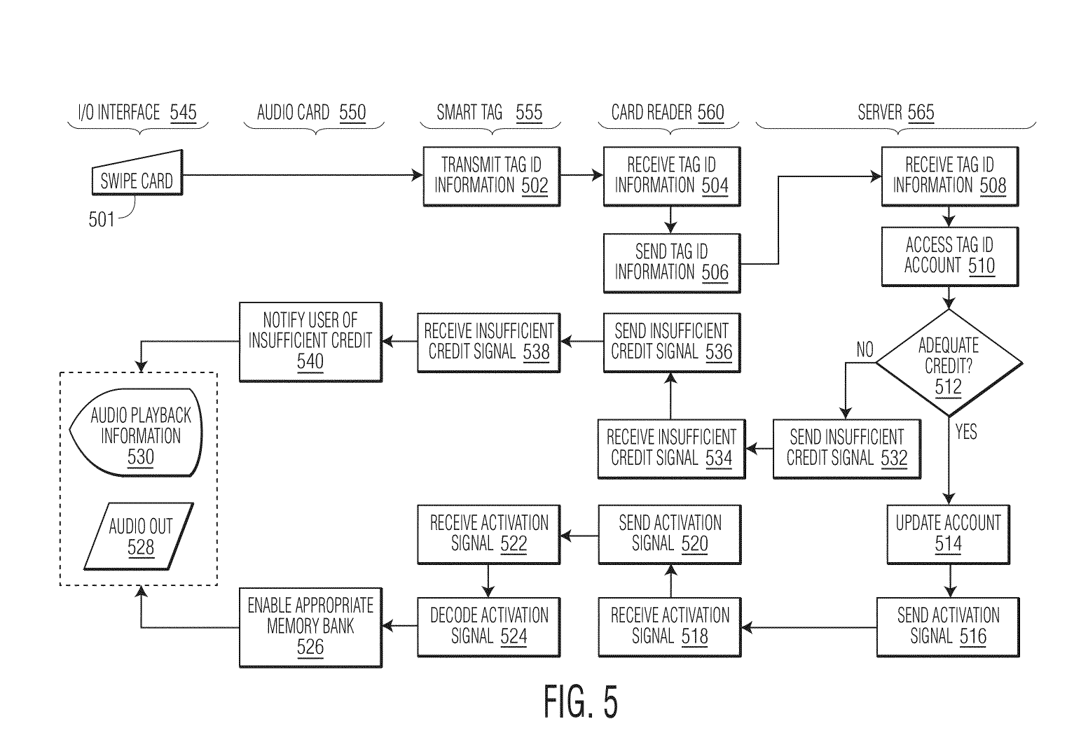

FIG. 5 is a logic flow diagram that illustrates operation of an exemplary e-ticketing enabled embodiment of the SMG. The logic flow diagram illustrates interaction and flow of data among various components including I/O interface 545, audio card 550, smart tag 555, card reader 560o, and server 565. Processing is initiated in response to a user swiping or tapping a smart card at 501 at, for example, an entrance to a museum. Upon swiping or tapping the smart card on a card reader 560, via RF induction, the smart tag 555 may get powered on to transmit a tag ID (or any identification or additional information) to the card reader 560 at 502. The card reader 560 may receive the tag ID at 504 and send the tag ID to the server 565 at 506. The server 565 may receive the tag ID at 508. Upon receiving the tag ID, the server 565 may access a corresponding tag ID account from a records database at 510. The retrieving of the tag ID account information may be implemented by using SQL statements. A determination 512 may be made at the server 565 whether the account associated with the tag ID has adequate credit to gain access to, for example, the museum. If there is an adequate credit, the server 565 may debit the account by the amount of the museum e-ticket and update the account information at 510 reflect the decreased credit amount available. Upon updating the account, the server 565 may send an activation signal at 516 to the card reader 560. The card reader may, after receiving the activation signal at 518, allow the user access to the museum (e.g., by opening a door, allowing user to turn a turnstile, etc.). The card reader 560 may also send the activation signal to the smart tag 555 at 520. The smart tag 555, may receive the activation signal at 522, and may decode the activation signal at 524 (e.g., using a switching circuit). The decoded activation signal may then enable appropriate memory banks in the ROM at 526. Audio out 528 and/or display information 530 may also be made available for the user.

In one implementation, for example, an SMG for New York City museums may comprise audio tracks for the Solomon R. Guggenheim Museum, the Brooklyn Museum and the American Museum of Natural History. A user, who decides to visit the Guggenheim Museum, may arrive at an access point at the museum and may tap, swipe or pass his or her smart card on or over a card reader at the access point. A remote server may, in response to the tapping, check the amount of credit on his or her smart card. If the credit is enough for an e-ticket, the user may be allowed entrance to the museum. The smart card may then decode the activation signal to enable those memory bank locations that contain stored content for the Guggenheim Museum. The smart card may playback the stored content for the Guggenheim Museum when requested by the user via the controls on the exterior of the smart card.

On the other hand, it may be the case that a user does not have enough credit. In such a case, the server 565 may send an insufficient credit signal 53 to the card reader 560. The card reader may receive the signal 532 at 534 and may pass along the signal at 536 to the smart tag 555 at 538. From the smart tag 555, the audio card 550 may receive the signal and may notify the user of insufficient credit at 540 via audio 528 and/or display 530. The user upon being informed of insufficient credit, may in one embodiment, go to a top up station or kiosk and purchase more credit for his or her smart card.

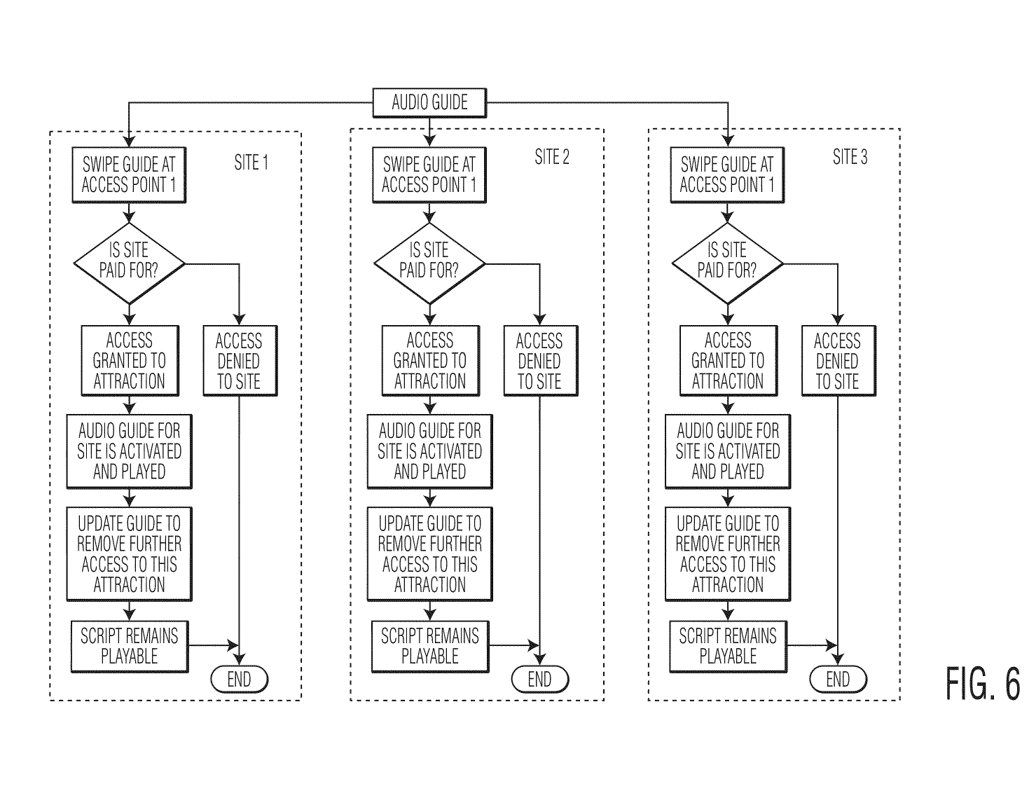

FIG. 6 is a logic flow diagram that illustrates operation of an exemplary e-ticketing enabled embodiment of the SMG in multiple sites.

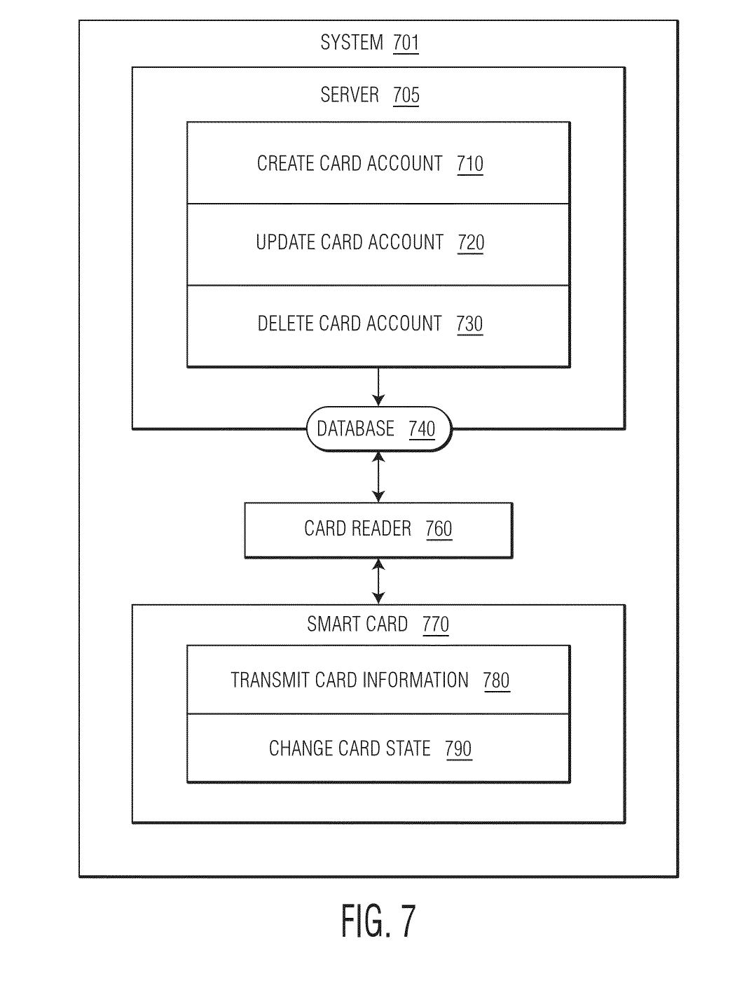

FIG. 7 is a block diagram illustrating the exemplary e-ticketing enabled embodiment of the SMG of FIG. 6. The system 701 may comprise one or more servers 750, one or more databases 740, card reader 760 and a smart card 770. The server 750 may be configured to facilitate creation of a smart card account 710. The smart card account 710 may include card information such as tag ID, credit amount, track list, and/or the like. The server 750 may also keep track of credit spending, credit top up, no activity in credit, etc. and update card account 720 accordingly. The server may also delete card account 730 when necessary. For example, in one embodiment, if the SMG is a three museum visit e-ticket, after the third museum visit, the card account may be deleted to prevent further access and prevent users from topping up their credit. In another embodiment, the SMG may allow a finite number of credit top ups until all the tracks have been unlocked and/or until all the participating sites have been visited. In a further embodiment, the server 750 may delete an account associated with a smart card that has been unused for more than a prescribed period of time, for example one month, three months, one year, and/or the like.

The card reader 760 as described above may be available at a site access point for reading smart cards 770 and communicating with the server 750. The card reader may also be available at stations/kiosks for purchasing a new smart card or adding credit to existing smart cards. The smart card 770 may function to transmit card information 780 (e.g., tag ID) and to receive control signals from the card reader. In response to the receipt of control signals from the card reader, the smart card 770 may, in one embodiment, change the card state 790. For example, if the signal is an “allow” signal, the “inactive” smart card state may be changed to “active” smart card state. The active smart card state may allow access to stored content and/or designated sites.

In some embodiments the SMG further comprises a transmitter, which may be discrete, or integrated into the receiver as a transceiver. In some embodiments, the transceiver comprises a low-power, sub-i GHz front end transceiver.

### Beacon-Enabled SMGs

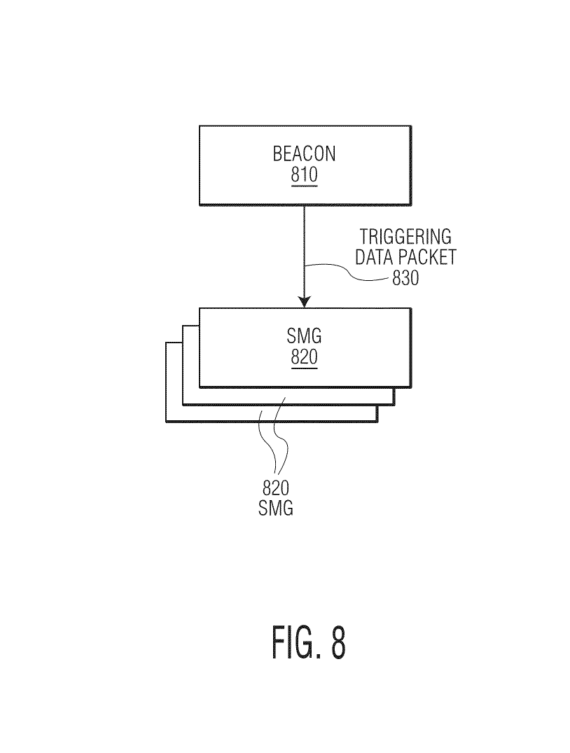

In some embodiments, the present invention is directed to uni-directional beacon-triggered SMG systems. FIG. 8 illustrates an embodiment of such a system. Beacon Bio periodically transmits a Triggering Data Packet 830. Such transmission is broadcast via any convenient medium, including RF, ultra-wideband, and WiFi. After the transmission, the beacon goes into a sleep mode in which current to the components is dropped to a minimal level to save battery reserve until an internal clock indicates time for transmission of the next Triggering Data Packet 830.

Each beacon is configured to transmit triggering data packet at a predetermined triggering interval. The predetermined triggering interval is configurable. Typical predetermined triggering intervals are in the range of from about 100 ms to about 10 s, and include intervals of about looms, about 200 MS, about 300 ms, about 500 ms, about 700 ms, about is, about 5 s and about 10 s. A predetermined triggering interval of about 1 second is preferred.

The Triggering Data Packet 830 comprises a data string that is configured to be recognized by an SMG to trigger it to access and play a particular track of digital content stored thereon. The Triggering Data Packet 830 may comprise subpackets dedicated to such information as type of trigger, location identifier, track number identifier, and cyclic redundancy check (“CRC”). Types of triggers may include triggers to access and play digital audio content, triggers to emit a SMG identifier for the purpose of obtaining a count or of locating SMGs, triggers to actuate an alarm or other sound, or a mechanism, or to prevent a mechanism from being actuated, and debugging triggers. Location identifiers may signal to which among a number of locations this trigger relates. The track number identifier identifies which track of digital content prerecorded on the SMG memory the SMG is to access and play. The CRC allows the SMG to conduct a message error detection algorithm. If the CRC algorithm fails, the packet is deemed corrupted and disregarded. In some embodiments, the Triggering Data Packet 830 may not include all of the type, location identifier, track number, and cyclic redundancy check (“CRC”) subpackets. For example, in some embodiments, only a track number identifier subpacket is included in the Triggering Data Packet 830.

SMG 820 receives the Triggering Data Packet 830 and unless an error is detected, accesses the track number corresponding to the track number indicated in the appropriate subpacket and plays the digital content of that track. After the track is played, or after the user interrupts play, play is stopped and the SMG goes into a sleep mode in which current to the components is dropped to a minimal level to save battery reserve until it receives a Triggering Data Packet corresponding to another track.

The system may comprise a plurality of SMGs and a plurality of beacons. In some embodiments, beacons are fixed to specific locations and SMGs are mobile, free to enter the range of any or all beacons serially. In some embodiments, the beacons are mobile and the SMGs are fixed to a specific locations. In some embodiments, both the beacons and the SMGs are mobile.

### Disablement/Re-Enablement

In some circumstances, the audio guide may be provided to a user to allow access to the digital content for what is essentially a one-time use. This might be the circumstance in the case where the audio guide functions as the provider of a tour to the user at a specific tour site. After the user completes the tour, she may not have any further use for the audio guide. In such a circumstance, it may be desirable to recycle the audio guide by collecting the used audio guide, reconditioning it as needed, repackaging the audio guide with any associated materials such as a map, and providing it for future use by other users at the tour site, thus avoiding introduction into the waste stream of the used audio guide. However, the risk of introducing recycled audio guides into the market is that collected a used audio guide may be diverted from the site operator's collection point and resold or otherwise redirected to a second user, thus depriving the site operator any fee associated with providing the second user with the audio guide, and thus disincentivizing the site operator from engaging in a recycling program. Thus, it would be advantageous to control the ability to access the digital content of an audio guide after its digital content has been accessed by a user.

Hence, in some embodiments, upon satisfaction of a Disablement Criterion, the Microcontroller 203 will not allow the Play Unit 215 to allow access to the digital content. The Disablement Criterion may be satisfied by any of a number of occurrences including completion of the playing of the last track in the sequence (e.g., completion of playing of Track 14, where Track 14 is the last track in a sequence of fourteen tracks). Alternatively, the Disablement Criterion could be met by passage of a specific time period since initial battery insertion at Battery Unit 120, or power-on or initial play by user (e.g., 4 hours from the first time the digital content is accessed by a user through the User Interface Unit 208). Alternatively, the Disablement Criterion may be satisfied after all tracks have been initiated at least once.

In some embodiments, the audio guide is integrated into a Beacon-Based System. (See description below.) In such embodiments, the Disablement Criterion may be satisfied by the passage of a specific time period after reception at the audio guide of a data packet from the beacon associated with that track, (e.g., thirty minutes after reception at the audio guide from the beacon associated with Track 14 of a data packet associated with Track 14, where Track 14 is the last sequential track among fourteen tracks.)

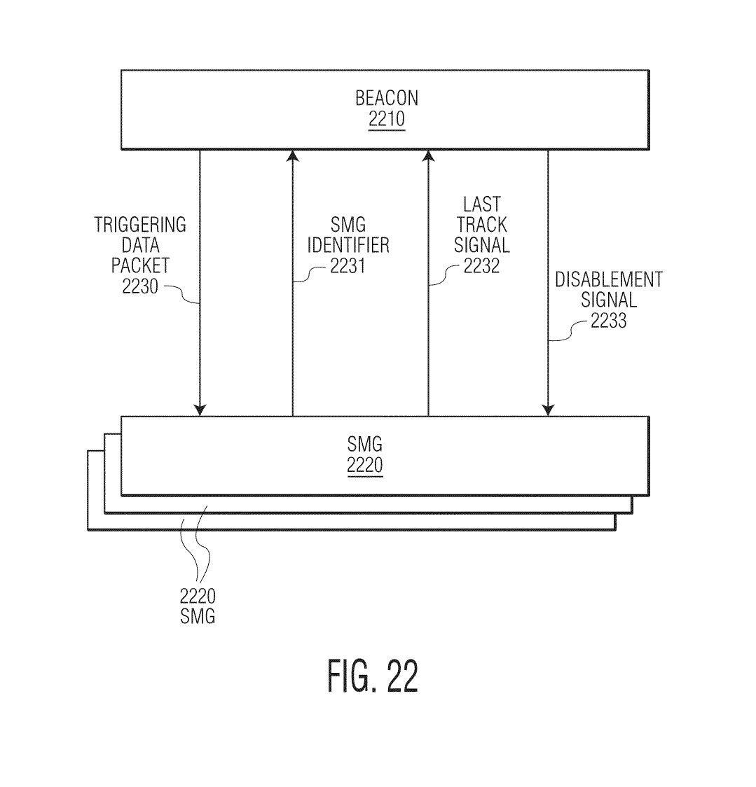

An embodiment of a beacon-based system for SMG disablement/re-enablement is illustrated in FIG. 22. SMG 2220 emits a signal, SMG Identifier 2231, which comprises SMG identifying information uniquely identifying that specific SMG, or identifying a group of SMGs (e.g., SMG serial number). In these embodiments, the SMG further comprises a transmitter, which may be a discrete component, or may be integrated into the receiver. In some embodiments, upon initiation of play of the last sequential track, or completion of play of the last sequential track, the audio guide transmits a data packet containing information indicating that play of the last sequential track has been initiated, or completed, respectively, as a Last Track Signal 2232. The Last Track Signal 2232 may be in addition to the SMG Identifier 2231, or alternatively may include in the transmitted data packet SMG identifying information uniquely identifying that specific SMG, and thus supplant transmission of the SMG Identifier. Upon receipt of a Last Track Signal 2232 at the beacon 2210 associated with the last sequential track, beacon 2210 transmits a Disablement Signal 2233 that includes information uniquely identifying the SMG 2220 and an instruction to disable further access of digital content in SMG 2220. The Disablement Criterion could be met by passage of a specific time period (e.g., thirty minutes) since receipt at the SMG of a Disablement Signal 2233 containing the unique identification of the SMG.

After an SMG has been disabled for play and collected by the site operator, in order to recycle it for future use by other users, it must be re-enabled for play. An SMG may be re-enabled for play in a variety of ways. In some embodiments, the SMG is re-enabled by receipt of a Re-Enablement Signal, which signals the SMG that digital content may thereafter be accessed. The Re-Enablement Signal may be transmitted by a dedicated Re-Enablement Device. The Re-Enablement Signal may be transmitted by the Re-Enablement Device via a variety of media including RF, ultra-wideband, WiFi, or infrared where the SMG comprises an infrared receiver. In some embodiments, the Re-Enablement Device is a handheld device maintained by the site operator, or by a system servicer. In some embodiments, the Re-Enablement Device transmits the Re-Enablement Signal via IR or low-power RF, ultra-wideband or WiFi, requiring the SMG to be to be “swiped” across an IR port or held in close proximity to the Re-Enablement Device, thus controlling receipt of the Re-Enablement and further controlling unauthorized use. In some embodiments, the SMG is labeled with an identifying bar code identifying it (e.g., by serial number, batch number, date of last issuance) and swiping the SMG by the IR port on the Re-Enablement Device allows the reading of the bar code information. Such information may be collected and stored in a local storage (e.g., disk drive, CD, flash drive, SIM card) and/or transmitted to a Data Gathering Facility (see below). In some embodiments, Beacon 2210 transmits the Re-Enablement Signal 2234.

In some embodiments, SMGs are inventoried in a disabled state, thus preventing unauthorized use (e.g., by theft). Authorized use is allowed by transmission of an Enablement Signal, similar to a Re-Enablement Signal, transmitted by an Enablement Device, similar to a Re-Enablement Device. The Enablement Device may be stationary or hand held.

### SMG Data Collection

In some circumstances, it may be desirable to obtain information regarding the behavior of users of SMGs, such as their time-stamped locations, their quantities, and the digital content accessed (e.g., which tracks or other content are initiated and/or played to completion). One advantage of collecting these data via the use of SMGs versus smart phones is that the data transmitted do not include any personal data of the user (e.g., name, address Social Security Number), any data regarding user internet habits, phone calls and text messages made or received, or prior user location data. Thus, threats to user privacy are greatly reduced, and prospective users may feel more comfortable using the SMGs.

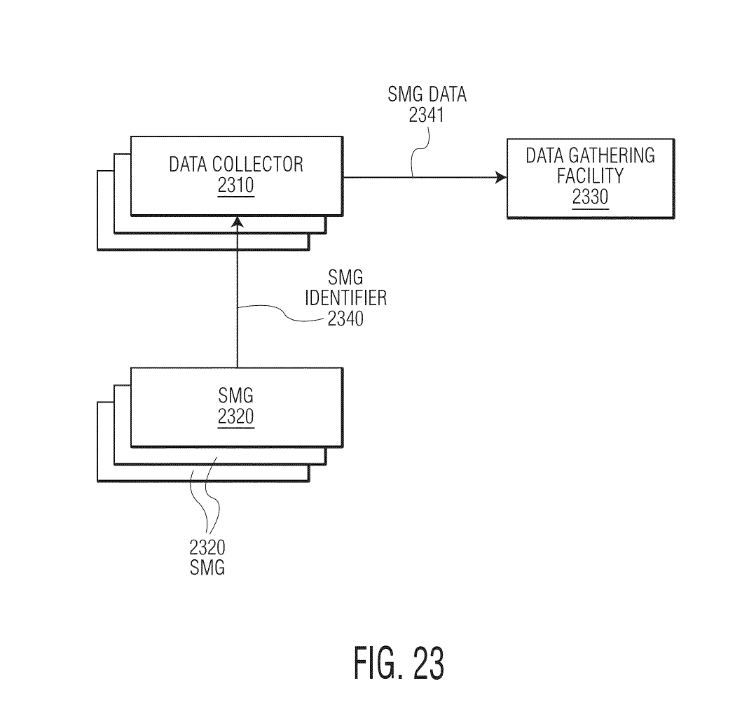

An embodiment of an SMG data collection system is illustrated in FIG. 23. SMG 2320 periodically transmits an SMG Identifier 2340. A local Data Collector 2310 receives the SMG Identifier 2340. In the case where a plurality of SMGs 2320 are transmitting SMG Identifiers 2340, Data Collector 2310 may collect all such received SMG Identifiers 2340 from SMGs within range of its receiver for purposes of computing totals of unique users to have come within the vicinity of the Data Collector. This function could be useful for counting tourist visits to particular sites or commercial establishments at specific times. An arrangement of multiple Data Collectors would allow the locational tracking of specific users. In some embodiments, Data Collectors 2410 are connected to a central Data Gathering Facility 2330, and the SMG Data 2341 are continuously or periodically transmitted by the Data Collector 2310 to the Data Gathering Facility 2330. SMG Data 2341 can be collated, stored and analyzed either in real time or periodically. A Data Gathering Facility 2330 may comprise a server, PC, laptop, smartphone, or mainframe computer. Connection between the Data Collector 2410 and the Data Gathering Facility 2330 may be via cable, RF, ultra-wideband, WiFi, or any other data transmission method. In some embodiments, beacons comprise Data Collectors. In some embodiments, an SMG Identifier is stored as original content in an allocated space on a first SMG memory.

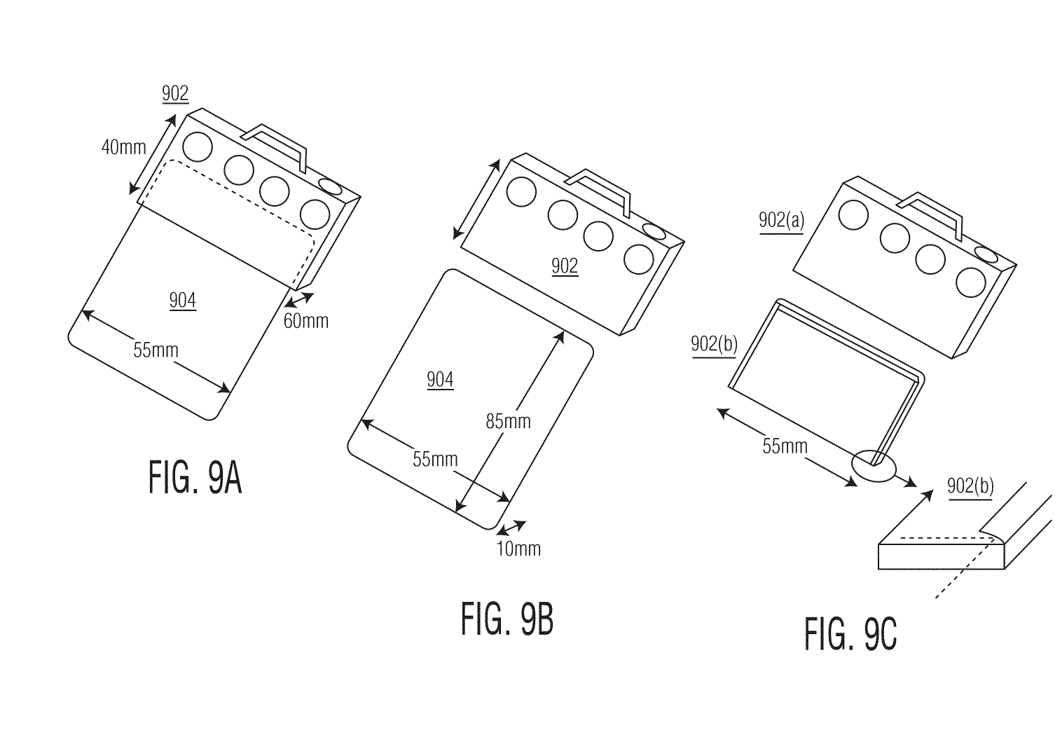

In another embodiment of the trigger enabled SMG, FIGS 9 illustrates content access or delivery activation based on a pass card 904. In some applications, users who have purchased for example a three-day metro pass for New York City may be rewarded by unlocking one or more contents in their SMG. Similarly, in some situations, users with prepaid cards/SIM cards may wish to purchase contents for delivery in their SMG. In such cases, the embodiments of FIG. 9 may be attractive. In one embodiment, a pass card 904 may include, for example, credit card sized cards such as a transit pass, a ticket pass, a museum pass, a pre-paid card, and/or the like.

The SMG 902, as shown in FIG. 9 views 9(a), (b) and (c), comprises a front face 902(a) having a control panel and a rear face having a grooved and/or raised edge. The pass card 904 may be designed to slide into the SMG via the rear grooved edge as the SMG is held. The SMG may include a card reader (e.g., contactless or contact) that may read the pass information (e.g., via 2-D bar code, electrical contact, etc.) and may determine whether or not to unlock one or more contents for delivery to the user. In the case of pre-paid cards, the card reader may write updated data on the card to reflected debits after any purchase.

In one application, a trigger enabled SMG may be used in museums, galleries, auctions, and other events or places where items are exhibited for viewing, sale, etc. A trigger enabled SMG containing content related to, for example an item being auctioned, may be provided to a user. In one implementation, an item being auctioned and the user's SMG may communicate via Bluetooth technology to allow the user access to content related to a description, history, price and other information associated with the item. In other implementations, SMG communication is achieved by alternative means, including RFID tags, high precision location sensors and/or the like.

In one embodiment, a passive trigger enabled SMG may include an image sensor that captures images. For example, in a museum visit, a 2-D barcode may be located next to a painting of interest. Using an image sensor integrated with the trigger enabled SMG, an image of the 2-D barcode may be captured and processed to select content corresponding to the painting for a user.

In some situations when two transponders are located close to each other, a user's SMG may experience conflict and may play content related to the last received tag. While transponders may be located far enough apart and/or range or power adjusted so as not to interfere with each other, sensitivity filters may be incorporated in SMGs to ensure conflict resolution. For example, a user walking through a historic town may find himself in between two historic building each of which has a transponder. In one implementation, the transponders next to each other may not be synchronized, such that a data packet is not sent out at the same time and will not be received by an SMG at the same time. In another implementation, an SMG may include a sensitivity filter that establishes a priority. Examples of a sensitivity filter may include a user's content consumption history, time of receipt, popularity of transmitting location, proximity, frequency and/or the like. In one implementation, the sensitivity filter may be configured in such a way that after receiving a trigger from a first transponder, the receiver may be temporarily disabled and content may be selected and played. The receiver may not be re-enabled until the user stops the content or a specified length of content has been played. One or more of these filters may be implemented via software code stored in the memory.

In other embodiments suitable to very closely spaced beacons, such as might be the case in a museum or library, the power of the beacon is modulated to a very low level, thus decreasing the effective transmission range of its signals, and requiring a user to approach a beacon within lesser radius (e.g., 2-5 meters) to receive a signal of sufficient strength to trigger the SMG. In some embodiments, the beacon transmits the triggering signal via IR and the SMG is preconfigured to read the IR signal. The user would have to swipe the SMG by the IR port of the beacon to trigger the appropriate content to be played.

### Widely-Interactive SMG Systems

In some circumstances, it would be desirable to allow the SMG to receive content transmitted from an exogenous source, and for that content to then be made accessible to the user. Nonlimiting examples of such content include information regarding site updates, weather, material associated with a particular track, commercial promotions, operation of the SMG, and entertainment content such as music and poetry. These functionalities would make the SMG more informative, and able to provide the user with information in a much more flexible manner than solely accessing material stored on a ROM memory chip within the SMG.

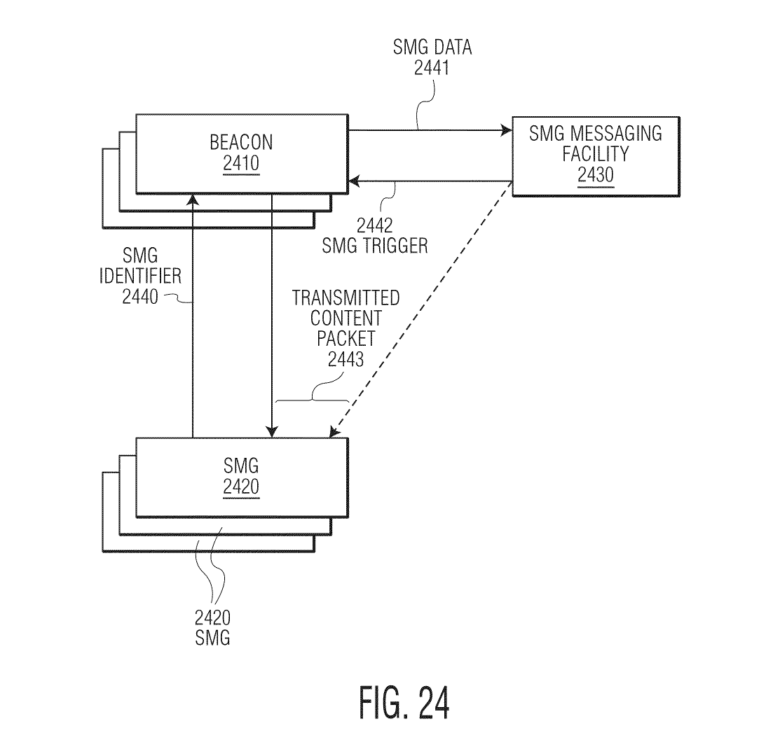

An embodiment of a widely interactive SMG system is illustrated in block diagram format in FIG. 24. SMG 2420 comprises a Second SMG Memory writeable memory chip for storage and retrieval of content transmitted from an exogenous source. In some embodiments, the original digital content has been stored on the writable memory, and any new content is to be stored at alternate addresses on the writable memory. In other embodiments, SMG 2420 further comprises ROM memory in which original digital content has been stored. SMG 2420 periodically transmits SMG Identifier 2440 signal.

Beacon 2410 receives SMG Identifier 2440 signal. In some circumstances, there may be a plurality of SMGs 2420 within range of the Beacon 2410 reception. Beacon 2410 receives all such SMG Identifier 2440 signals, and if a broadcast criterion is satisfied, transmits Transmitted Content Packet 2443. Transmitted Content Packet 2443 may comprise the transmitted content to be transmitted to the SMG or SMGs, the identities of which SMG or SMGs are to be instructed to store and/or play such content, and instructions for playing the content. SMG 2420 receives Transmitted Content Packet 2443, determines whether the instruction applies by checking for a match between its identity and that SMG or SMGs identified in Transmitted Content Packet 2443. If a match is found, the content is stored in the SMG writeable memory or temporary memory. The transmitted content is played according to the instructions for playing the content in the Transmitted Content Packet 2443. Such instructions may direct that the SMG play the transmitted content immediately, interrupting any track that may have been in the process of playing. Alternately, the instructions may direct that the transmitted content is to be played at the conclusion of a track that is playing, or at the conclusion of a different track.

In some embodiments, the exogenous source comprises a Broadcast Control Unit selected from the group consisting of a beacon, server, PC, laptop, smartphone, and mainframe computer. Where the Broadcast Control Unit is a server, PC, laptop, smartphone, or mainframe computer, the exogenous source further comprises a transceiver configured to transmit the Transmitted Content Packet. The exogenous source is configured to transmit a Transmitted Content Packet upon satisfaction of a Broadcast Transmission Criterion.

In some embodiments, the Broadcast Transmission Criterion is satisfied by receipt of a SMG Data 2441. In other embodiments, the Broadcast Transmission Criterion is satisfied on a predetermined chronological basis (e.g., every hour on the hour, or once every 45 minutes). In yet other embodiments, the Broadcast Transmission Criterion is satisfied by instructions from a system manager. In yet other embodiments, the Broadcast Transmission Criterion is satisfied by receipt of an SMG Identifer.

In other embodiments, after Beacon 2410 receives SMG Identifier 2440 signal it stores it, and transmits it to SMG Messaging Facility 2430 either in real time as received, or periodically batchwise. SMG Messaging Facility 2430 receives SMG Identifier 2440 signal and may store it, collate it into a file of such signals for reporting and analysis. In one embodiment, if a Broadcast Transmission Criterion is satisfied, SMG Messaging Facility 2430 transmits SMG Trigger 2442 signal to Beacon 2410. SMG Trigger 2442 comprises information regarding the content to be transmitted to the SMG or SMGs, and identifies which SMG or SMGs are to be instructed to store and/or play such content. The information regarding the content to be transmitted to the SMG or SMGs may be the content itself, or identification of such content that is stored on Beacon 2410.

In alternate embodiments, the SMG Messaging Facility 2430 transmits Transmitted Content Packet 2443 directly to SMG 2420, forgoing the intermediate step of transmission of the SMG Trigger 2442 to Beacon 2410.

In yet other embodiments, content is unilaterally broadcast from an exogenous source, without the requirement for any prior transmission or receipt of SMG Identifier 2440. The exogenous source may broadcast content based on a predetermined chronological basis, or based on instructions from a system manager.

In some embodiments, after receiving a Transmitted Content Packet, the smart media guide stores it in a second SMG memory, and upon satisfaction of a Play Criterion, accesses and plays the Transmitted Content through the SMG user output interface. In some embodiments, the Play Criterion is satisfied by receipt of the packet. In other embodiments, the Play Criterion is satisfied by the conclusion of any track that is being played when the packet is received. In other embodiments, the Play Criterion is satisfied by entry of a play command by the user through the SMG user interface.

Targeted Content Transmission

In some embodiments, an exogenous source broadcasts an Identification Command Signal. The exogenous source may broadcast the Identification Command Signal either on a chronological basis (once per hour on the hour) or upon instruction from a system manager. When an SMG receives an Identification Command Signal, it will broadcast an SMG Identifier. Any of the steps described herein as occurring upon receipt of an SMG Identifier may then occur. In this way, an In-Range Survey can be compiled reflecting all SMG's within range of that exogenous source at any given time, or over any time period. In some embodiments, an exogenous source broadcasts Targeted Content targeted to some SMGs reflected in the In-Range Survey. The Targeted Content includes the SMG identifying information from the SMG Identifiers of the targeted SMGs. Upon receipt of the Targeted Content, an SMG will compare the SMG identifying information in the Targeted Content to that stored as Original Content. If there is a match, the Targeted Content will be stored, placed into temporary memory, or if an instruction file, acted upon. The exogenous source that broadcasts the Identification Command Signal is not necessarily the same exogenous source that broadcasts the Targeted Content.

Any or all of signals SMG Identifier 2440, SMG Data 2441, SMG Trigger 2442 and Transmitted Content Packet 2443 may comprise a CRC subpacket to facilitate error detection.

SMG Messaging Facility 2430 may comprise a server, PC, laptop, smartphone, or mainframe computer. Connection between the Beacon 2410 and the SMG Messaging Facility 2430 may be via cable, RF, ultra-wideband, WiFi, or any other data transmission method. In some embodiments, SMG Messaging Facility 2430 comprises a Data Gathering Facility 2330. In some embodiments, Beacon 2410 comprises Data Collector 2310.

### FM Enabled SMG

In many cities and popular tourist areas, tour buses routinely employ loud speakers to provide riders commentary on sites of interest. The loud speakers are a source of noise pollution and may be a nuisance to residents inhabiting surrounding area. The conventional solution to this problem may be to retro-fit all buses with hardwired audio terminals that may be accessed by headsets plugged into an audio jack. This solution has various financial and logistical drawbacks. The cost of fitting new buses and retro-fitting old buses with the hard wired communications system may be high. Furthermore, logistical problems including the issuing and collecting of headsets may result in extra labor costs for tour operators and costs to cover accidental loss and damage of headsets. Additionally potential health concerns with sharing headsets may have to be investigated.

A wireless SMG embodiment presents a possible solution to this problem. The wireless SMG may be pre-loaded with tourist audio scripts and may include an FM receiver. In one embodiment, the FM receiver may be paired with an FM Transmitter on the tour bus. When in transit on the bus the tour information may be broadcast wirelessly over the air and be picked up by the FM receivers on the bus need. In a further embodiment, customers may be able to take the SMG off the bus and may use the SMG for a walking tour of the city. In one implementation, the FM transmitter unit may not be built into the bus. In a further implementation, the transmitter units may be small portable units that may be carried around with ease by a bus operator. In one implementation, a low powered FM transmitter with a long co-axial based antenna may be positioned at the side of the bus or in the center of the bus. The power output of the transmitter may be kept below certain levels in compliance with FCC regulations. In another implementation, FM airspace from the FCC may be purchased by tour bus operators. The licensed bandwidth may then be used by tour operators to transmit audio information to passengers. In a further implementation, ISM bands may be used to transmit content over the air. ISM bands are free to use to anyone with reasonable power usage and may require either no or minimal change to the existing buses.

In some situations, two or more buses using the same transmission frequency may be in the vicinity of each other. In such situations, possibility of interference may be high. In one implementation, interference between different transmitters may be reduced by giving an antenna that runs along the length of a bus a limited range (e.g., 2m) of transmission. The range of transmission may be limited by reducing the transmission power.

### Real Time Locating Enabled SMG

In one embodiment, an SMG may be implemented as a Real Time Locating (RTL) system. For example, in some medical facilities, it may be useful to provide a RTL enabled SMG having one or more tags to each patient in order to track their location and/or ascertain quickly their medical history including current medications. Such an RTL enabled SMG may include a read/write memory that may act as a repository of a patient's pertinent or all medical history including prescription, dosage, disease, and/or the like. Further, information may be written to the memory, as for example prescriptions, doses and other information may change with time. An RTL enabled SMG may also include an analog to digital converter, modulator/demodulator, transceiver and any other RF front end components. An RTL enabled SMG may transmit a data packet that may be received by an access point (e.g., a computer). In one implementation, the tags may be transmitted and/or received via a e network (IEEE 802.11 standards). In another implementation, ultra-wideband (UWB) signals may be used for data communication between an RTL enabled SMG and a receiving application. In a further implementation, multiple access points may be utilized to increase accuracy of locating an RTL enabled SMG in a network. Although, an RTL enabled SMG is discussed herein in the context of a patient tracking and patient data repository system, an RTL enabled SMG may have applications in other areas including location-triggered applications (e.g., trigger enabled SMG), product tracking, in processing plants, and/or the like. In one implementation, commercially available high precision sensors (e.g., DecaWave's ScenSor chip) may be incorporated into an SMG to provide real time locating functionality. RTL systems may also find applications in locating specific items, animals or people from a collection of like items, animals or people. Thus, RTL systems may find uses in locating personal luggage at a baggage claim, specific cattle within a herd, or specific children on a playground.

### SMG Content

Contents for SMG may be created or tailored based on applications. For example, contents available via SMG may include health education/information (nutrition, anti-smoking, and diabetes), money matters (financial advice, consumer advice), corporate messaging (conference messages, training information, and infomercials), citizen advice (rights, safety advice), audio books, e-books, movies/video clips, images, and/or the like. In one embodiment, the contents may be available in many languages. The contents created and/or tailored for the SMG may be made available for purchase and/or download via other smart phones and/or computing systems. In one implementation, SMG contents may be made available via a companion website. In another implementation, SMG contents may be provided or sold through an SMG content application (e.g., an SMG app available from iTunes) downloadable to smart phones and other media players. In one embodiment, 2D barcodes on advertisement posters, pamphlets, etc. may be scanned using smart phones to purchase and/or download associated content. In another embodiment, the physical casing of the SMG may be covered by content specific skin or design. For example, an SMG for London may have a skin or jacket that features one or more images representative of London.

SMG BOOKS

Some embodiments of the present invention are directed to an SMG that has a store of digital audio content and the controls and speaker(s) suitable for playing back such content for a user in a convenient manner. Such digital audio content may be a recorded voice of a reading of a book, series of books, or magazines, legal or scientific documents or any other written matter.

In the case of many books of medium to extended length, the size of the raw WAV or MPdigital audio file may exceed the size of a standard memory chip available at a price that will keep the overall SMG Book price competitive. This challenge may be overcome by storing the digital audio file in a compressed format via any commercially available data compression software (e.g., WinZip® supplied by WinZip International and PKZIP® supplied by PKWARE). The compressed digital audio files are stored in the SMG Book's archive memory. When the user is ready to play the first track, he selects it, which cues the SMG Book to move the first track into a play memory, decompress it, and then to initiate play. At the end of that track, he selects the next track. This cues the SMG Book to recompress the first track, move it back into archive memory, move the second track into play memory, decompress it, and start playing it.

### SMG Controller

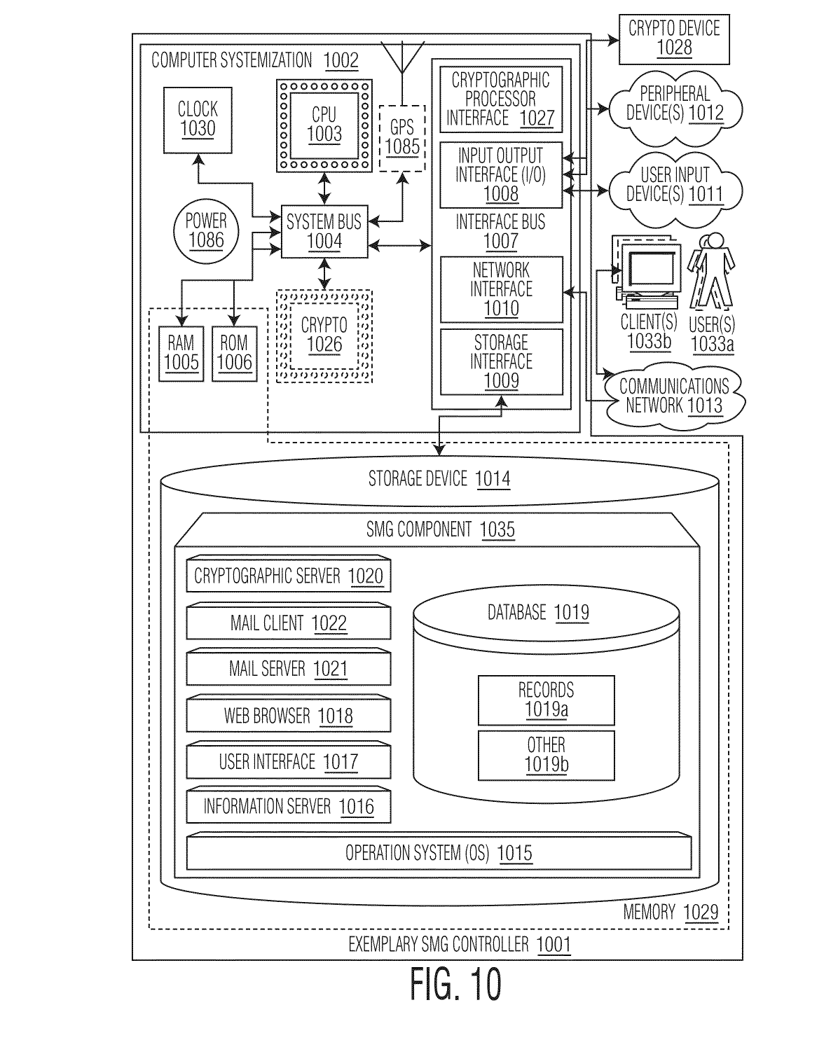

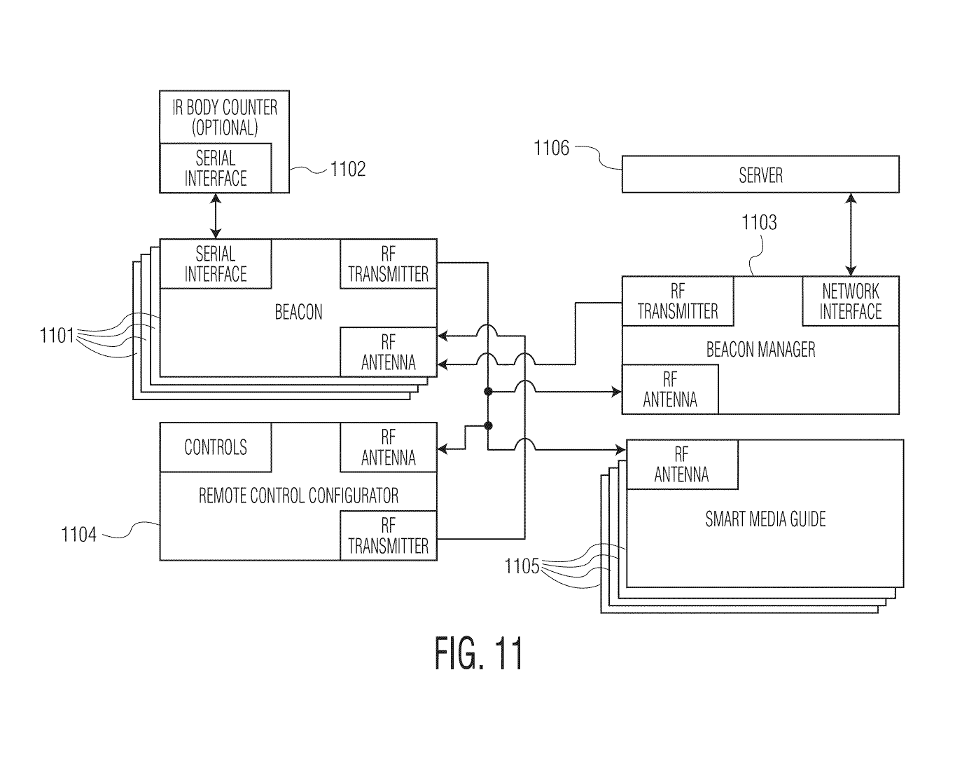

FIG. 10 illustrates inventive aspects of a SMG controller 1001 in a block diagram. In this embodiment, the SMG controller 1001 may serve to aggregate, process, store, search, serve, identify, instruct, generate, match, and/or facilitate interactions with a computer through media player technologies, and/or other related data.

Typically, users, which may be people and/or other systems, may engage information technology systems (e.g., computers) to facilitate information processing. In turn, computers employ processors to process information; such processors 1003 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 1029 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the SMG controller 1001 may be connected to and/or communicate with entities such as, but not limited to: one or more users from user input devices loll; peripheral devices 1012; an optional cryptographic processor device 1028; and/or a communications network 1013.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The SMG controller 1001 may be based on computer systems that may comprise, but are not limited to, components such as: a computer systemization 1002 connected to memory 1029.

### Computer Systemization

A computer systemization 1002 may comprise a clock 1030, central processing unit (“CPU(s)” and/or “processor(s)” (these terms are used interchangeable throughout the disclosure unless noted to the contrary)) 1003, a memory 1029 (e.g., a read only memory (ROM) 1006, a random access memory (RAM) 1005, etc.), and/or an interface bus 1007, and most frequently, although not necessarily, are all interconnected and/or communicating through a system bus 1004 0n one or more (mother)board(s) 1002 having conductive and/or otherwise transportive circuit pathways through which instructions (e.g., binary encoded signals) may travel to effect communications, operations, storage, etc. Optionally, the computer systemization may be connected to an internal power source 1086. Optionally, a cryptographic processor 1026 may be connected to the system bus. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 529 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the SMG controller and beyond through various interfaces. Should processing requirements dictate a greater amount speed and/or capacity, distributed processors (e.g., Distributed SMG), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the SMG may be achieved by implementing a microcontroller such as CAST's R8051XC2 microcontroller; Intel's MCS 51 (i.e., 8051 microcontroller); and/or the like. Also, to implement certain features of the SMG, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the SMG component collection (distributed or otherwise) and/or features may be implemented via the microprocessor and/or via embedded components; e.g., via ASIC, coprocessor, DSP, FPGA, and/or the like. Alternately, some implementations of the SMG may be implemented with embedded components that are configured and used to achieve a variety of features or signal processing.

Depending on the particular implementation, the embedded components may include software solutions, hardware solutions, and/or some combination of both hardware/software solutions. For example, SMG features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the SMG features. A hierarchy of programmable interconnects allow logic blocks to be interconnected as needed by the SMG system designer/administrator, somewhat like a one-chip programmable breadboard. An FPGA's logic blocks can be programmed to perform the function of basic logic gates such as AND, and XOR, or more complex combinational functions such as decoders or simple mathematical functions. In most FPGAs, the logic blocks also include memory elements, which may be simple flip-flops or more complete blocks of memory. In some circumstances, the SMG may be developed on regular FPGAs and then migrated into a fixed version that more resembles ASIC implementations. Alternate or coordinating implementations may migrate SMG controller features to a final ASIC instead of or in addition to FPGAs. Depending on the implementation all of the aforementioned embedded components and microprocessors may be considered the “CPU” and/or “processor” for the SMG.

### Power Source

The power source 1086 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 1086 is connected to at least one of the interconnected subsequent components of the SMG thereby providing an electric current to all subsequent components. In one example, the power source 1086 is connected to the system bus component 1004. In an alternative embodiment, an outside power source 1086 is provided through a connection across the I/O 1008 interface. For example, a USB and/or IEEE1394 connection carries both data and power across the connection and is therefore a suitable source of power.

Any size battery of sufficient charge and feasible size may be used to power the SMG and beacon, selected independently. Battery sizes that may be suitable for the SMG and beacon include 1.5-, 3-, 6-, 9- and 12-volt, AA, AAA, C and D.

### Interface Adapters

Interface bus(ses) 1007 may accept, connect, and/or communicate to a number of interface adapters, conventionally although not necessarily in the form of adapter cards, such as but not limited to: input output interfaces (I/O) 1008, storage interfaces 1009, network interfaces 1010, and/or the like. Optionally, cryptographic processor interfaces 1027 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 1009 may accept, communicate, and/or connect to a number of storage devices such as, but not limited to: storage devices 1014, removable disc devices, and/or the like. Storage interfaces may employ connection protocols such as, but not limited to: Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 1010 may accept, communicate, and/or connect to a communications network 1013. Through a communications network 1013, the SMG controller is accessible through remote clients 1033b (e.g., computers with web browsers) by users 1033a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed SMG), architectures may similarly be employed to pool, load balance, and/or otherwise increase the communicative bandwidth required by the SMG controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 1010 may be used to engage with various communications network types 1013. For example, multiple network interfaces may be employed to allow for the communication over broadcast, multicast, and/or unicast networks.

Input Output interfaces (I/O) 1008 may accept, communicate, and/or connect to user input devices 1011, peripheral devices 1012, cryptographic processor devices 1028, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless: 802.11a/b/g/n/x, Bluetooth, code division multiple access (CDMA), global system for mobile communications (GSM), WiMax, etc.; and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 1011 may be card readers, dongles, finger print readers, gloves, graphics tablets, joysticks, keyboards, mouse (mice), remote controls, retina readers, trackballs, trackpads, and/or the like.

Peripheral devices 1012 may be connected and/or communicate to I/O and/or other facilities of the like such as network interfaces, storage interfaces, and/or the like. Peripheral devices may be audio devices, cameras, dongles (e.g., for copy protection, ensuring secure transactions with a digital signature, and/or the like), external processors (for added functionality), goggles, microphones, monitors, network interfaces, printers, scanners, storage devices, video devices, video sources, visors, and/or the like. In one embodiment, peripheral devices 1012 may include devices for writing content to memory (e.g., devices used by manufacturers to program content to memory and other components).

It should be noted that although user input devices and peripheral devices may be employed, the SMG controller may be embodied as an embedded, dedicated, and/or monitor-less (i.e., headless) device, wherein access would be provided over a network interface connection.

Cryptographic units such as, but not limited to, microcontrollers, processors 1026, interfaces 1027, and/or devices 1028 may be attached, and/or communicate with the SMG controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Equivalent microcontrollers and/or processors may also be used. Other commercially available specialized cryptographic processors include: the Broadcom's CryptoNetX and other Security Processors; nCipher's nShield, SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+ MB/s of cryptographic instructions; VLSI Technology's 33 MHz 6868; and/or the like.

### Memory

Generally, any mechanization and/or embodiment allowing a processor to affect the storage and/or retrieval of information is regarded as memory 1029. However, memory is a fungible technology and resource, thus, any number of memory embodiments may be employed in lieu of or in concert with one another. It is to be understood that the SMG controller and/or a computer systemization may employ various forms of memory 1029. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory 1029 will include ROM 1006, RAM 1005, and a storage device 1014. A storage device 1014 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Operating System

The operating system component 1015 is an executable program component facilitating the operation of the SMG controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Nan 9; Be OS; Unix and Unix-like system distributions (such as AT&T′s UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the SMG controller to communicate with other entities through a communications network 1013. Various communication protocols may be used by the SMG controller as a subcarrier transport mechanism for interaction, such as, but not limited to: multicast, TCP/IP, UDP, unicast, and/or the like.

### Information Server

An information server component 1016 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the SMG controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the SMG database 1019, 0perating systems, other program components, user interfaces, Web browsers, and/or the like.

Access to the SMG database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the SMG. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the SMG as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

The function of computer interfaces in some respects is similar to automobile operation interfaces. Automobile operation interface elements such as steering wheels, gearshifts, and speedometers facilitate the access, operation, and display of automobile resources, functionality, and status. Computer interaction interface elements such as check boxes, cursors, menus, scrollers, and windows (collectively and commonly referred to as widgets) similarly facilitate the access, operation, and display of data and computer hardware and operating system resources, functionality, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 1017 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 1018 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the SMG enabled nodes. The combined application may be io nugatory on systems employing standard Web browsers.

### Mail Server

A mail server component 1021 is a stored program component that is executed by a CPU 1003. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP₃), simple mail transfer protocol (SMTP), and/or the like. The mail server can route, forward, and process incoming and outgoing mail messages that have been sent, relayed and/or otherwise traversing through and/or to the SMG.

Access to the SMG mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 1022 is a stored program component that is executed by a CPU 1003. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP₃, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 1020 is a stored program component that is executed by a CPU 1003, cryptographic processor 1026, cryptographic processor interface 1027, cryptographic processor device 1028, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the SMG may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the SMG component to engage in secure transactions if so desired. The cryptographic component facilitates the secure accessing of resources on the SMG and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The SMG Database

The SMG database component 1019 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the SMG database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the SMG database is implemented as a data-structure, the use of the SMG database 1019 may be integrated into another component such as the SMG component 1035. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated. In one embodiment, the database component 1019 includes several tables 1019a-b. A records table 1019a includes fields such as, but not limited to: a tag_ID, device_ID, balance_amt, purchased_track_ID, free_track_ID, and/or the like. The records table may support and/or track multiple entity accounts on a SMG.

In one embodiment, the SMG database may interact with other database systems. For example, employing a distributed database system, queries and data access by search SMG component may treat the combination of the SMG database, an integrated data security layer database as a single database entity.

In one embodiment, user programs may contain various user interface primitives, which may serve to update the SMG. Also, various accounts may require custom database tables depending upon the environments and the types of clients the SMG may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 1019a. The SMG may be configured to keep track of various settings, inputs, and parameters via database controllers.

The SMG database may communicate to and/or with other components in a component collection, including itself, and/or facilities of the like. Most frequently, the SMG database communicates with the SMG component, other program components, and/or the like. The database may contain, retain, and provide information regarding other nodes and data.

### The SMGs

The SMG component 1035 is a stored program component that is executed by a CPU. In one embodiment, the SMG component incorporates any and/or all combinations of the aspects of the SMG that was discussed in the previous figures. As such, the SMG affects accessing, obtaining and the provision of information, services, transactions, and/or the like across various communications networks.

The SMG component enables the data receiving, processing, exchange, access personalization and/or the like and use of the SMG.

The SMG component enabling access of information between nodes may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the SMG server employs a cryptographic server to encrypt and decrypt communications. The SMG component may communicate to and/or with other components in a component collection, including itself, and/or facilities of the like. Most frequently, the SMG component communicates with the SMG database, operating systems, other program components, and/or the like. The SMG may contain, communicate, generate, obtain, and/or provide program component, system, user, and/or data communications, requests, and/or responses.

### Alternate Embodiments of Beacon-Based Systems

In some embodiments of the present invention, one or more deacons is to emit a signal to one or more remote receiver units. Depending on the application, an action may be triggered in the receiving unit if the received strength of the signal exceeds a maximum, or drops below a minimum, or is merely detected at a sufficient signal strength.

In some embodiments, this technology is beneficially applicable in the tourism industry, where tour site operators may be faced with the challenge of providing large numbers of clients with individualized tours throughout their sites in a manner that is time-convenient to clients and otherwise provides a smooth and intuitive experience to the clients. In some embodiments, a Beacon-based system in a museum would be comprised of elements shown in FIGURE ii, and in its simplest form of a series of SMGs 1105, 0ne issued to each tourist walking through the museum, and a series of Beacons 1101 mounted close to items of interest. Each SMG 1105 is comprised in its simplest form of a memory storing digitized audio content regarding each item of interest, a receiver (including an antenna), a microcontroller, a power source, an interface and input/output port for earphone or headphones. Each Beacon 1101 comprises in its simplest form of a transmitter, a microcontroller and a power source. The Beacon 1101 emits a signal that identifies itself (its ID) on a regular basis. The SMG 1105 receives the ID signal from the Beacon, measures the strength of that received ID signal as an RSSI value, and if that RSSI value meets a minimum value deemed sufficient to distinguish the signal from background noise, the audio track associated with that ID is played for the client (proximity criterion). The effect is that if the client is within a predetermined distance of the item of interest, the appropriate audio track will automatically play without the client having to find the index number associated with the item of interest on a wall or elsewhere, and then punch it into the device, as is the case for other devices. Thus, an effortless tour experience is provided to the client.

One function of the Beacon 1101 is to periodically emit an ID signal from a transmitter. In some embodiments, the transmitter will comprise a directional antenna, useful in dense deployments, perhaps indoors, to reduce interference and to direct the signal appropriately (e.g., down a corridor). The Beacon signals emitted at a given strength will have various RSSIs depending on the location of the receiving SMG. The area within the locus of points where beacon signals satisfy the RSSI-based criterion is referred to as the beacon's Area of Prominence.

Some deployments may be tightly spaced, or at times densely populated, potentially placing a challenge on the effectiveness of the reception of the Beacons' signals by the SMGs. Thus, in some embodiments, an optional Infrared Body Counter (“IR Body Counter”) 1102 is provided. Communication with the Beacon 1101 is achieved through respective Serial Interfaces. The IR Body Counter 1102 measures the count of clients in the approximate Area of Prominence, transmits the count to the Beacon 1101, which then adjusts the RSSI and frequency of its emission to adjust for the new count. In some embodiments, the Beacon 1101 transmits the count to the Beacon Manager 1103 which may transmit the count data to the Server 1106 for storage and later analysis. In some embodiments, the Beacon Manager 1103 will use the count data transmitted from the Beacons 1101 to calculate updated RSSIs and frequencies for the Beacons 1101. The IR Body Counter 1102 may alternatively be in direct communication with the Beacon Manager 1103, which may be equipped with a Serial Interface. In this case, the Beacon Manager 1103 may either transmit the counts to the respective Beacons 1101, or make the calculations and transmit the updated RSSIs and frequencies.

In some embodiments, the power source of the Beacon 1101 is AC, and in other embodiments it is DC. In the DC embodiments, battery life may be an issue. Thus, in some DC embodiments, the Beacon 1101, transmits the battery status to the Beacon Manager 1103. Battery status is given as either of “Power On” or “Low Power.” The Beacon Manager 1103 transmits any “Low Power” battery status signals to the Server 1106 as an alert to the System Manager.

In some situations, it may be the case that several Beacons 1101 are deployed such that their signals may interfere with one another if not otherwise managed. In such situations, it may be advantageous to deploy an embodiment of the invention further comprising a Beacon Manager 1103, which is a device that dynamically configures each beacon by measuring and, if appropriate, adjusting its signal strength to achieve a predetermined Area of Prominence for each Beacon 1101, as determined by its respective signal strength. Preferably, the Beacon Manager 1103 is located such that it can receive the signal of all the Beacons 1101 whose signals may be competing in a space. In some embodiments, more than one Beacon Manager 1103 may be deployed to effectively manage all the Beacons 1101 in a space. In some embodiments, the Beacon Manager 1103 communicates through a Network Interface to Server 1106, which maintains and transmits to the Beacon Manager 1103 the site's Map of Prominence, which is comprised of the individual Beacon's Areas of Prominence, and stores client data for analytic purposes.

Alternatively, the Server may store and transmit any other beacon broadcast criterion. As used herein, the term “beacon broadcast criterion” means a standard against which the beacon system will be measured and targeted to meet. An individual beacon's broadcast criterion might be its area of prominence. A beacon system's broadcast criterion might be its map of prominence. However, other broadcast criteria are possible, such as emitted magnitude of signal strength.

In some embodiments, a Remote Manual Configurator 1104 may be deployed to manually adjust the signal strengths of the Beacons 1101 remotely. Such manual adjustments would likely be done upon initial installation, and then periodically thereafter, especially if Beacon 1101 locations change, or the physical/acoustic characteristics of the site change. The Remote Manual Configurator 1104 may be deployed in systems that include or exclude the Beacon Manager 1103.

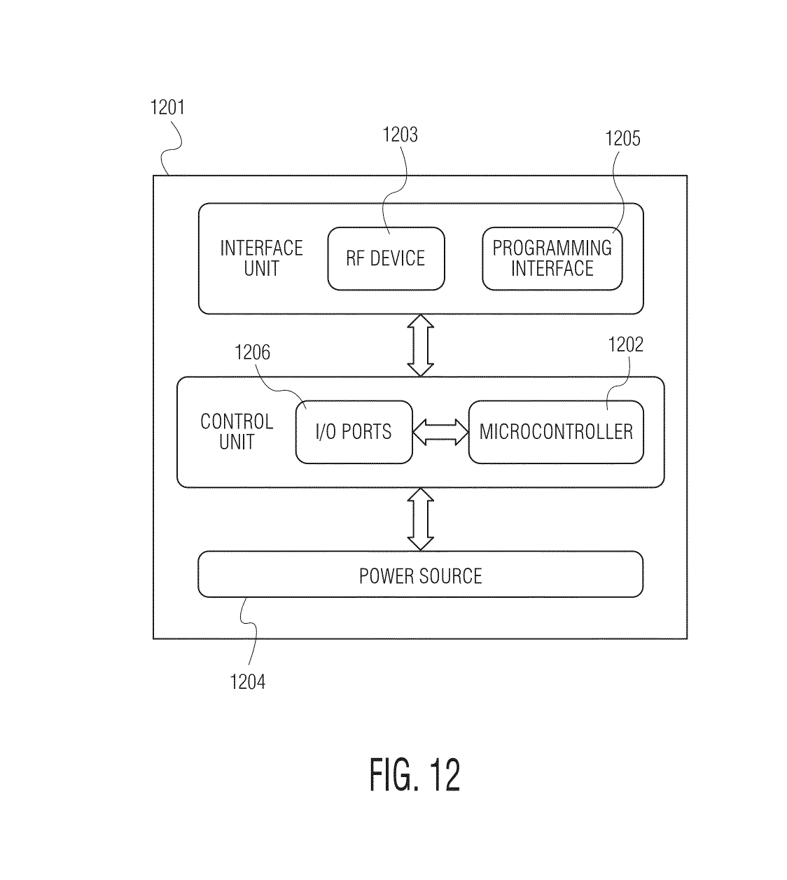

FIG. 12 is an illustration of an embodiment of a functional block diagram of a Beacon 1201. Microcontroller 1202 repeatedly loops through a program that causes the transmitter, shown here as RF Device 1203, to transmit a data packet at a regular Period of time. The Period with which the Beacons may be initiated may preferably be selected from the range of about 0.1 second to about 3.0 seconds, more preferably about 0.5 to about 1.5 seconds and most preferably, about 1 second. Between packet transmissions, the microcontroller 1202 powers down. Power source 1204 may be either AC or DC. Programming Interface 1205 allows users to set the RSSI and the Period for packet transmission. Input/Output Ports (“I/O Ports”) 1206 allow data transmission to other components. In some embodiments the microcontroller 1202 comprises a 16-bit, low power, RISC mixed-signal microprocessor. In some embodiments, the RF Device comprises a low-power, sub-1 GHz front end transceiver. The frequency band for transceiver operation may be selected from within the group consisting of 300-348 MHz, 387-464 MHz and 779-928 MHz. Preferred frequency bands include 315, 433, 868 and 915 MHz.

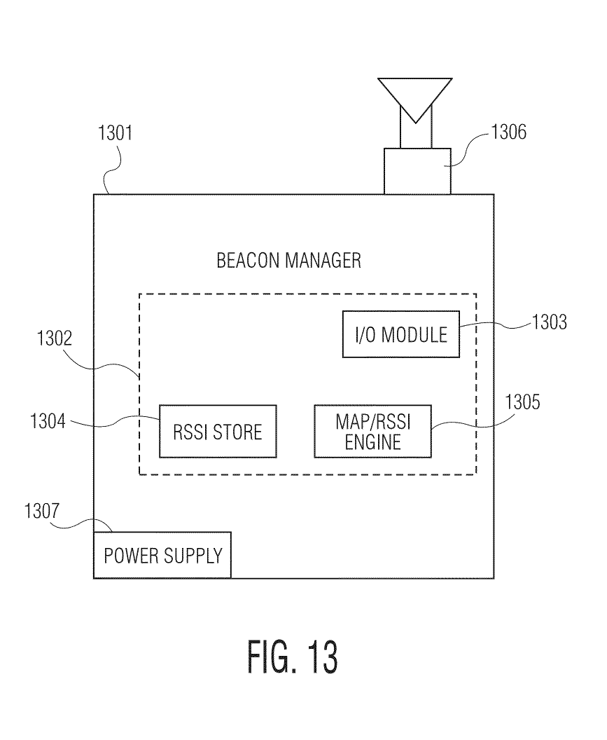

FIG. 13 is an illustration of an embodiment of a functional block diagram of a Beacon Manager 1301. Microprocessor 1302 receives ID packets from Beacons 1101 through RF Transceiver 1305, and stores the data at the appropriate registers in the RSSI Store 1304. Microprocessor 1302 also receives Map of Prominence through I/O Module 1303 from Server 1106 and stores it in Map/RSSI Engine 1305. Microprocessor 1302 then generates updated RSSIs and Periods to the respective Beacons through RF Transceiver 1305 as required to conform to the Map of Prominence.

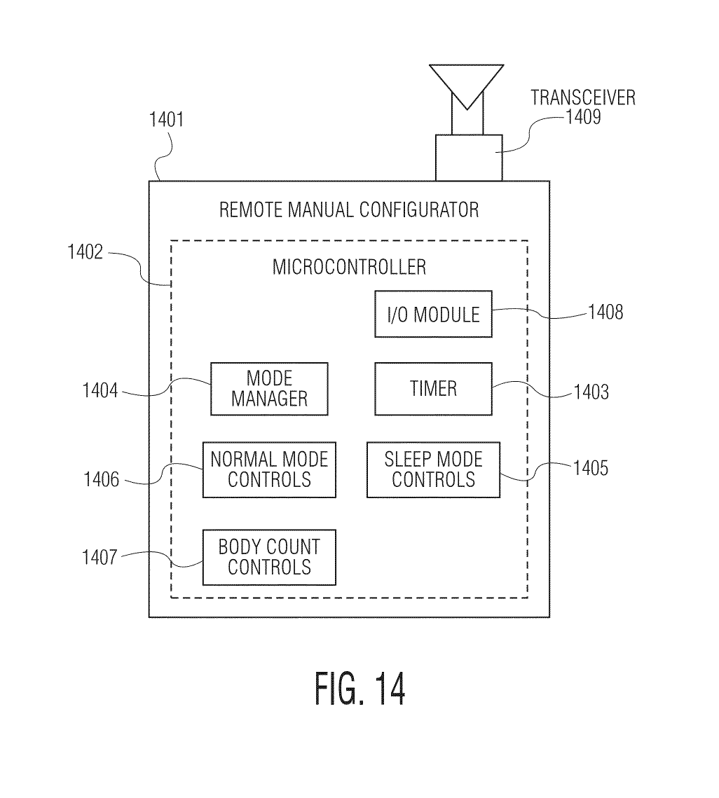

FIG. 14 is an illustration of an embodiment of a functional block diagram of Remote Manual Configurator 1401. Microcontroller 1402 comprises several functional software components, including: Timer 1403, which can be used to manually reset the Period of a Beacon 1101; Mode Manager 1404, which can be used to manually toggle the mode of the Beacon 1101 between Sleep and Normal modes; Sleep Mode Controls 1405, which allows sleep mode adjustments; Normal Mode Controls 1406, which allows normal mode adjustments; Body Count Controls 1407, which allows body count mode adjustments; and, I/O Module 1408, which manages the flow of data between the Remote Manual Configurator 1401 and the Beacons 1101 through the RF Transceiver 1409.

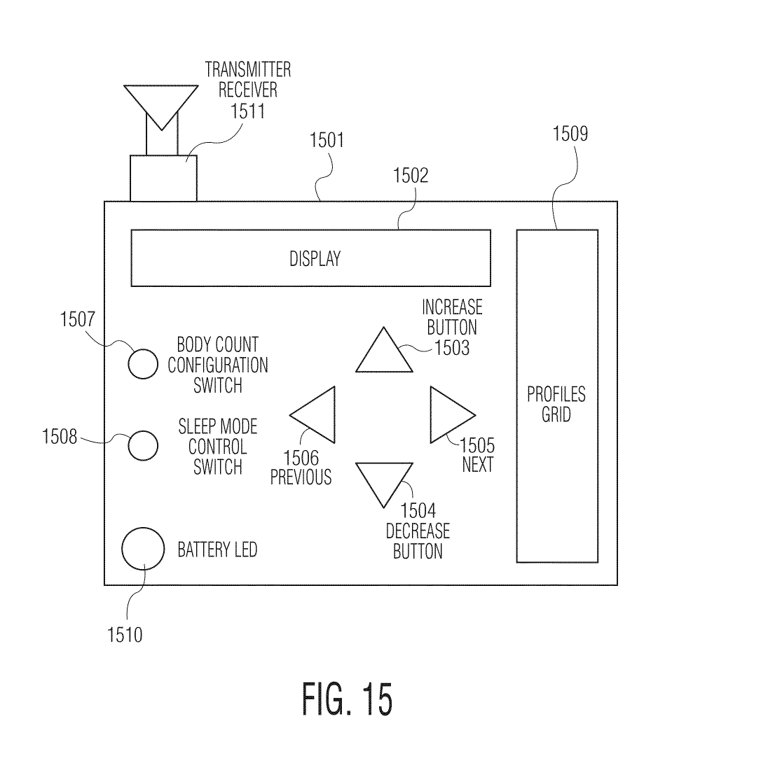

FIG. 15 is an illustration of an embodiment of an Interface of a Remote Manual Configurator 1501. The content exhibited on Display 1502 depends on the mode in which the Beacon is operating: in Normal Mode, Display 1502 exhibits the Beacon ID and RSSI; in Sleep Mode, it shows the start/end times for the Beacon; and, in IR Counter Mode, it shows the min/max body counting values for which the RSSI should not be modified. Increase Button 1503 increases the value displayed. Decrease Button 1504 decreases the value displayed. Next 1505 moves the item in the Display 1402 to the next data entry in the mode (e.g., in Normal Mode, the ID, the RSSI value and Period of the next Beacon in sequence). Previous 1506 likewise moves the item in the Display 1402 to the previous data entry in the mode. Body Count Configuration Switch 1507 allows the user to toggle into and out of Body Count Configuration Mode Controls. Sleep Mode Control Switch 1508 allows the user to toggle into and out of Sleep Mode Controls. Profiles Grid 1509 displays graphic projections of the Map of Prominence based on estimates from the received Beacon RSSIs. Battery LED 1510 indicates low power level in the battery in the Remote Manual Configurator 1501. Communications with Beacons 1101 are through Transceiver 1511.

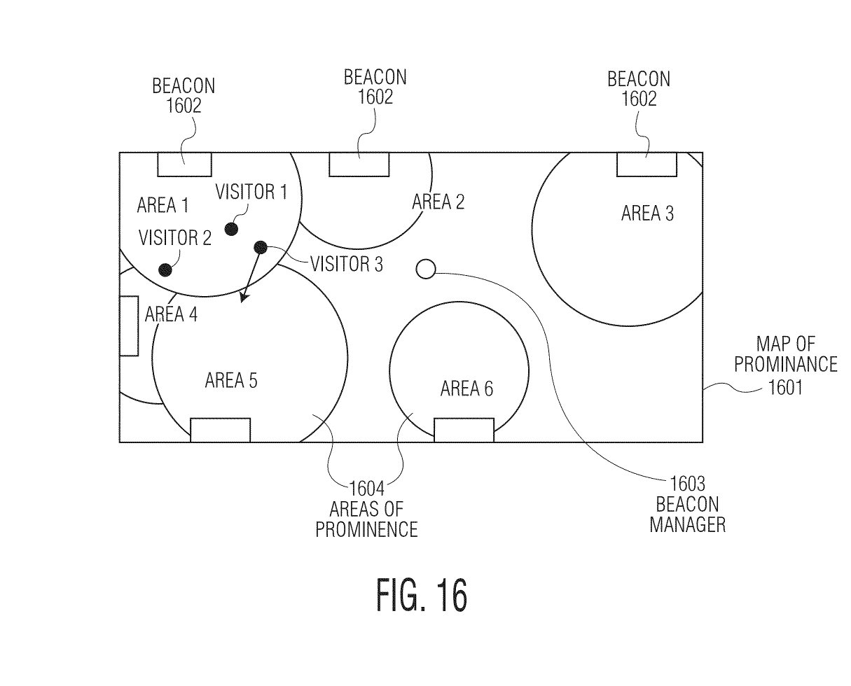

FIG. 16 is an illustration of an embodiment of a Map of Prominence 1601. A plurality of Beacons 1602 are mounted on the walls in a hall near items of interest to visitors who each have an SMG with digital audio content that will be triggered to play upon receipt of a data packet of sufficient RSSI (proximity criterion). Each Beacon 1602 is preassigned an Area of Prominence 1604 0ver which it is to extend a signal of sufficient RSSI to trigger and SMG to play. Beacon Manager 1603 is in the center of the room, perhaps mounted on the ceiling, monitoring signals from all Beacons 1602, and making adjustments to their respective emitted signal strengths and Period as needed. The Map of Prominence 1601 is digitally stored in the Server 1106 and updated as necessary. The Beacon Manager 1603 adjusts the emitted signal strengths and Periods of the Beacons 1602 to better conform to the Map of Prominence 1601 as provided by the Server 1106.

In some embodiments, the SMGs will further comprise an e-compass functionality that will allow the device to measure the direction relative to true north at io any time. With coordinates assigned to the Map of Prominence 1601, e-compass functionality will allow the determination as to whether the visitor is moving away from a first Beacon 1602 and toward a second. See Visitor 3. This would indicate that the visitor's interest has shifted from the first item of interest to the second item of interest. In that case, the audio track associated with the first Beacon would terminate, and the audio track associated with the second would trigger, for example before Visitor 3 reached Area 5.

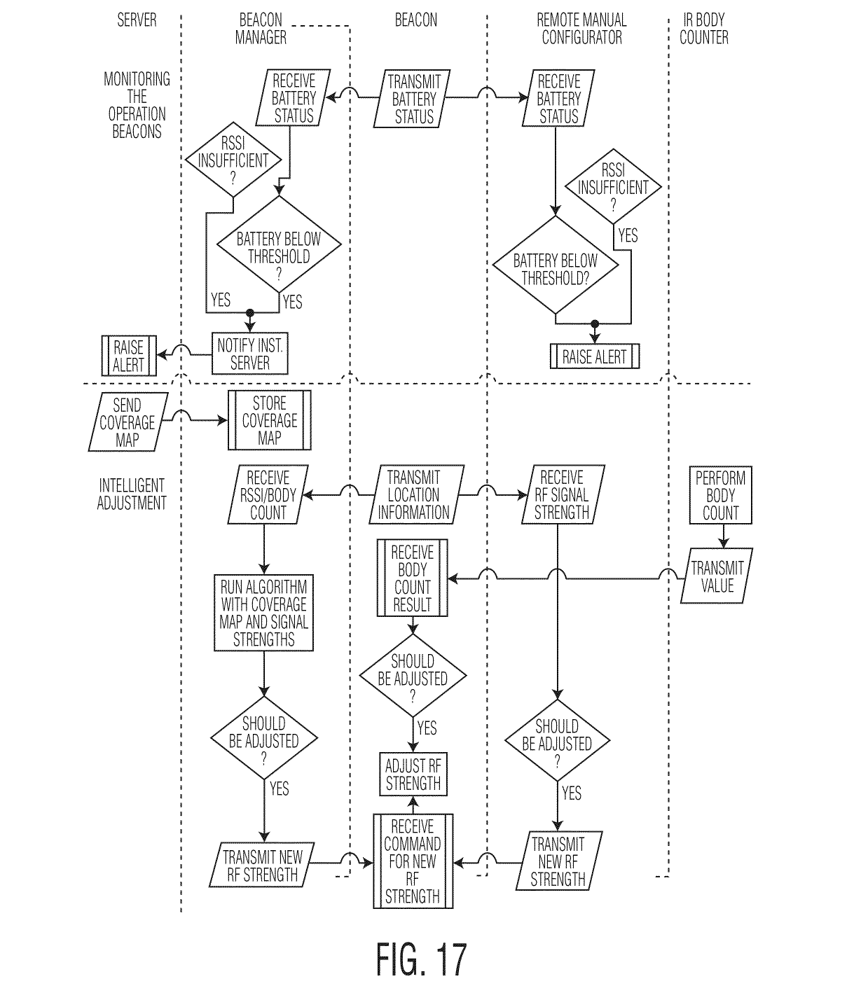

FIG. 17 is an illustration of an embodiment of a functional block flow diagram of the interactions among the Beacon 1101, the Beacon Manager 1103, the Remote Manual Configurator 1104, the IR Body Counter 1102 and the Server 1106. In the Monitoring function, the Beacon 1101 transmits its Battery Status to each of the Beacon Manager 1103 and the Remote Manual Configuator 1104, which then each checks whether the power level is below the allowable threshold or whether the RSSI was insufficient, and if so, transmits an alert message to the Server 1106.

In the Intelligent Adjustment function, the Server 1106 periodically transmits the Map of Prominence 1601 to the Beacon Manager 1103, which also receives Body Count information and RSSIs from each Beacon 1101, and uses these to run an algorithm to determine if the emitted signal strength of the Beacon 1101 should be adjusted. Any adjusted emitted signal strengths are transmitted to the respective Beacons 1101.

The Beacon Manager 1103 requires an initialization procedure in which the Remote Manual Configurator 1104 adjusts the signal strength of the Beacon 1101 and relays this information to the Beacon Manager 1103. In this way, the latter is aware of the expected signal strength on the edge of the Area of Prominence 1604 of each Beacon 1101.

During operation, the algorithm to recalculate the RSSI at the edge of the Area of Prominence 1604 uses
the RSSI received by the Beacon Manager 1103
the known signal strength transmitted by the Beacon 1101
the distance between the edge of the prevalence area, the Beacon 1101 and the Beacon Manager 1103
   the projected value RSSI value on the edge can be calculated during operation using the formula

20 log₁₀d=147,55+Pᵣₓ−Pₜₓ−Gₜₓ−Gᵣₓ=20 log₁₀f

where d is the distance (known from the Map of Prominence 1601), P the power in dBm of transmitter and receiver and G their antenna Gains.

If there is a difference between the projected value, i.e., the calculated RSSI in the edge of the Area of Prominence 1604, and the RSSI value stored during initialization by the Remote Manual Configurator 1104, the Beacon Manager 1103 signals the Beacon 1101 to amend its emitted signal strength in a gradual manner.

To improve the procedure of adjusting RSSI strengths under various environment changes (e.g., large crowds), the Remote Manual Configurator 1104 can be used during operation to provide real-time adjustments. Since these adjustments are known to the Beacon Manager 1103 along with the Body Count at the same time, they are stored and can be used to override calculated values.

Therefore, the Remote Manual Configurator 1104 provides redundancy to the signal strength management function if the automatic configuration by the Beacon Manager 1103 is found not to be satisfactory. Whenever Beacon Manager 1103 retrieves values stored by the Remote Manual Configurator 1104 regarding a Beacon 1101 and its Body Count, it uses these instead of the calculated values.

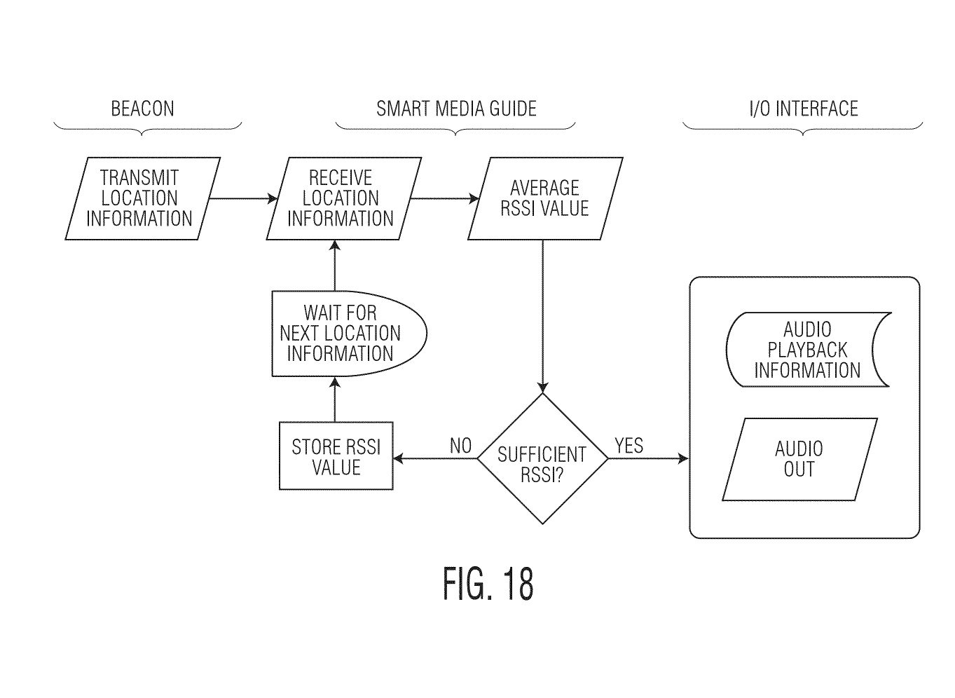

FIG. 18 is an illustration of an embodiment of a block diagram of the interactions among the Beacon 1101, the SMG 1105, and the SMG I/O Interface to the user. Beacon 1101 transmits a data packet including ID, which is received by SMG 1105. The RSSI is evaluated and it is determined whether it is sufficient to differentiate the Beacon's signal from noise (generally −90 to −100 dB). If the RSSI is sufficient, the audio track is triggered for the visitor. If not, the RSSI value is stored, the next signal is received from the Beacon 1101, the RSSI of the new signal is averaged with that of the prior signal and that averaged RSSI is evaluated for sufficiency. If sufficient, audio is triggered, if not, the RSSI value is stored and the loop continues. Areas of Prominence can be reduced by increasing the standard for sufficiency of the RSSI.

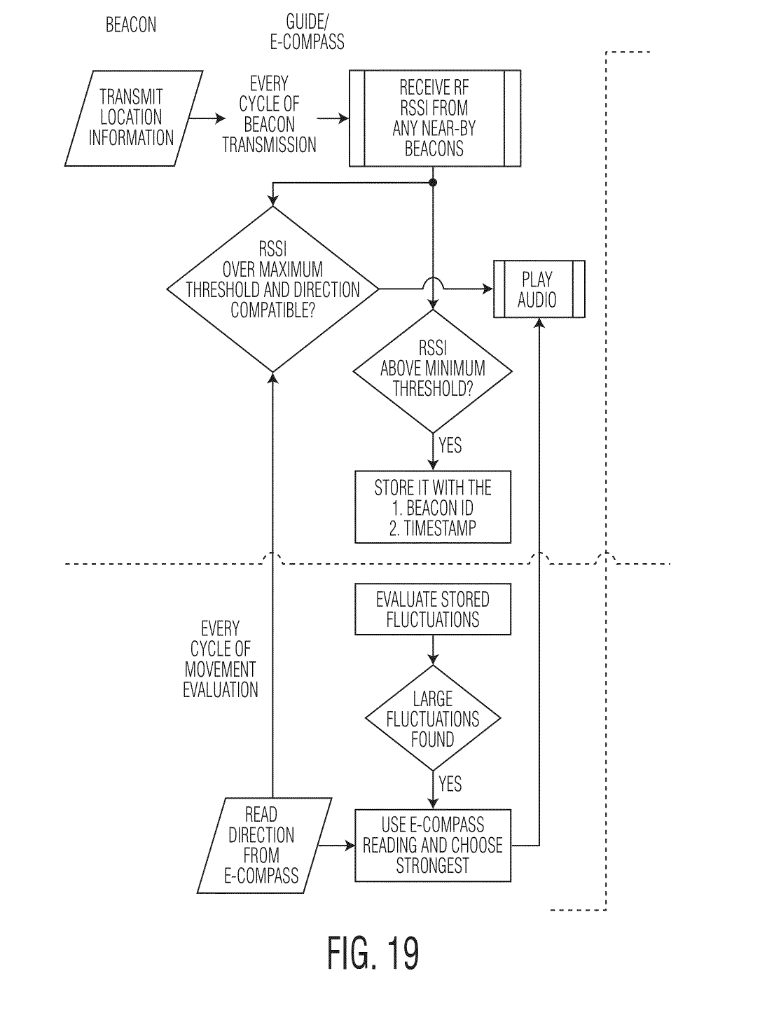

FIG. 19 is an illustration of an embodiment of a block flow diagram of the interactions between a Beacon 1101 and an SMG 1106 with an E-Compass. The Beacon 1101 periodically transmits its data packet including ID, which is received by the SMG 1106, which in turn examines the direction of the user based on history of previous stored RSSIs and the RSSI received. If either the RSSI exceeds a maximum, or a change in direction is detected and maintained for a sufficient time period, the audio track associated with the RSSI signal, or that is indicated by the vector of the change in direction is played.

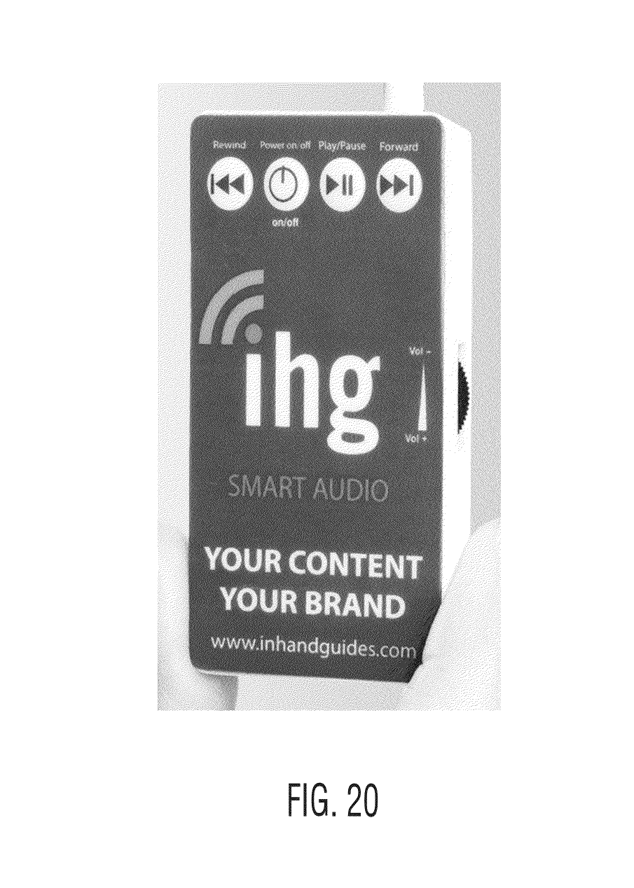

FIG. 20 is an illustration of an embodiment of the mechanical packaging and user controls of an SMG 1106. Push button membrane controls at the top of the unit allow the user to Rewind a track, Turn the unit On and Off, Play/Pause and Forward to the next track. Volume is controlled by a disk on the side of the unit. The headphone jack is on the top surface. The front and rear surfaces are available for client branding. The unit is lightweight, easy to use and conveniently dimensioned.

Beacon-based systems that trigger sensors in remote units (e.g., SMGs) to perform an action based on proximity or distance to the Beacon will have many applications. In some embodiments, the Beacon is fixed to one location. In other embodiments, the Beacon is mobile, carried by a person or a mobile device such as an automobile, a train locomotive or car, a golf cart, a fork lift, or a bicycle. In some embodiments, the triggered action is the playing of stored digital audio content. In other embodiments, the triggered action is the sounding of an audio alarm. In some embodiments, the triggered action is a flashing light. In some embodiments, the triggered action is the sounding of an audio alarm along with a flashing light. In some embodiments, the triggered action is the closing or opening of a door. In some embodiments, the triggered action is the delivery of a small electrical shock. In some embodiments, the triggered action is the actuation of a brake, the disengagement of a motor, the opening of a motorized door or the cessation of any other mechanically driven device operation. In some embodiments, a Beacon Manager is incorporated into one or more of the Beacons. In some embodiments, the communications link between the Beacon and the Beacon Manager is hardwired.

As used herein, the term “remote unit” means any device that receives the signal emitted by a Beacon and evaluates the RSSI of the beacon's signal to determine whether to initiate an action. Thus, remote unit includes appropriately equipped SMGs, security badges, pet collars, wrist bands, barricade fixtures, tickets, luggage tags, key fobs, and any other items that are adaptable to this technology.

In some embodiments, the Beacon-based system is designed for underwater use. The Beacon that is position near an item of interest underwater, perhaps a coral formation or a shipwreck feature, emits signals in sonar. An SMG receiving the sonar signal of sufficient strength is triggered to play stored digital audio content to a snorkel or scuba diver who swims within the path of the emitted sonar signal. All components are designed to be water-tight to the intended depths of deployment. In other embodiments, the Beacon triggers a sensor on the hull of a passing ship to play stored digital audio content for sight seers, or to sound an alarm or to send a message to the ship instrumentation controls or server. In some embodiments, the Beacon-based system is deployed in underwater environments featuring rocky outcroppings, sandbars, or other hazard features to act as a warning to ships that approach.

In some embodiments, the Beacon-based system is deployed in the healthcare setting, for example, systems that alert to movement of an individual outside a fixed setting. With an elderly population, the risks of those vulnerable adults (with or without dementia) moving outside their setting is an increasingly recognized issue. So the use of door locking or alarm to prevent movement outside an area or, to identify if someone has exited a room, a ward, a floor, or a facility has potentially substantial opportunities. The application would be of particular interest in neonatal wards to ensure safety of newborns where fears of abduction may be considered. Thus, in some embodiments, the remote sensing device is worn by a person, the triggering criterion is failure to detect signal of sufficient RSSI for a sufficient period of time (distance criterion) and the triggered action is the sounding of an audible alarm. In some embodiments, the audible alarm is accompanied by a flashing light. The sufficient period of time is long enough to avoid nuisance alarms, and short enough to allow timely detection and apprehension of any missing person. In some of these embodiments, one or more Beacon Managers are deployed to maintain the system reliability and flexibility.

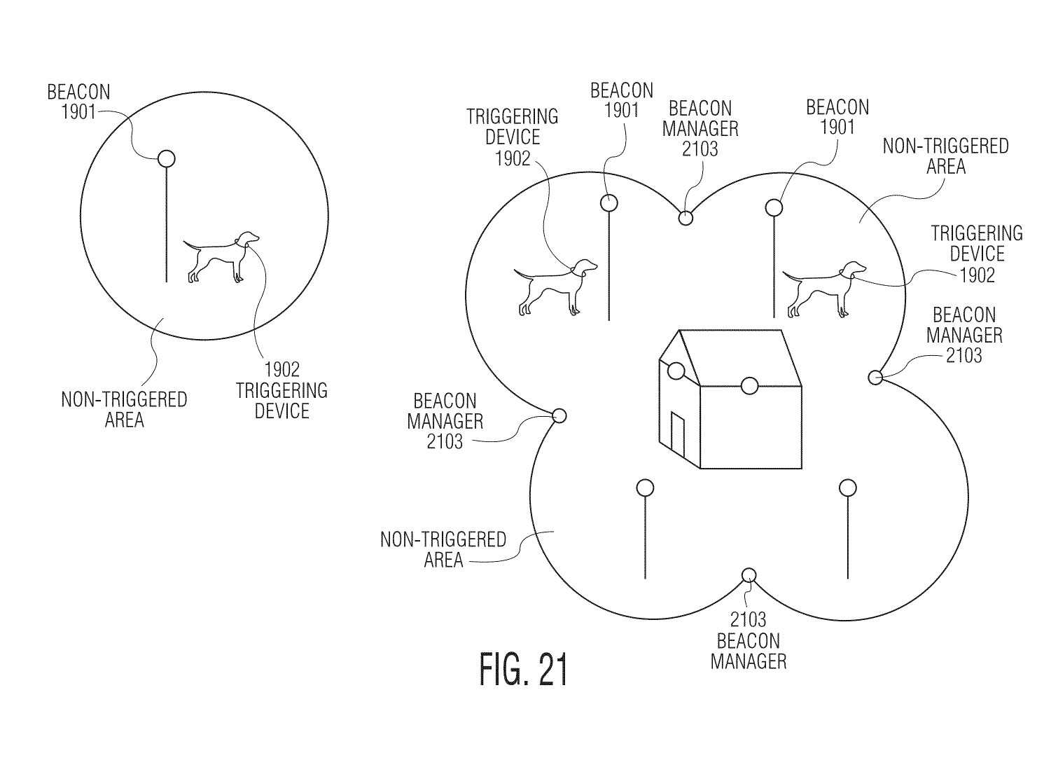

In some embodiments, the Beacon-based system is applied to the management of pets. FIG. 21 is an illustration of an embodiment of a pet management system according to the present invention. As shown in the diagram to the left, Beacon 1901 creates an area of prominence. The pet, illustrated here as a dog, wears a Triggering Device 1902. The triggering criterion is failure to detect a signal of sufficient RSSI for a sufficient period of time (distance criterion) and the triggered action is the delivery of a mild electrical shock to the dog. Thus, the area of prominence becomes the Non-Triggered Area. In the diagram to the right is shown an embodiment with multiple Beacons 1901 arranged around a structure, here illustrated as a house, such that the intersecting areas of prominence of each of the Beacons 1901 form a contiguous Non-Triggered Area around the house, allowing the dogs, wearing the Triggering Devices 1902 to roam the circumference of the house, without leaving the vicinity, thus providing guard duty if desired. Beacon Managers 1903 monitor the signal strengths of the Beacons 1901 and issue adjustments as required. Beacons 1901 may alternatively be mounted on the side of the structure as shown. This Beacon-based system would allow a user to achieve 360 degree range for pets around a house at a reasonable installed cost without any monthly subscription fees, as are usually associate with buried electronic fences.

In some embodiments, the Beacon-based system is used for crowd control. Beacons may be arranged behind barricades upon which remote units are mounted. Each remote unit is equipped with a sensor and a triggering mechanism. Barricades are designed such that they can not be outwardly moved, only inwardly moved by a crowd. The triggering criterion is detection of signal with sufficient RSSI (proximity criterion). The triggered action may be release of paint (for identification by police), tear gas or mace, or stun gun discharge. This system would prevent a considerable number of injuries to police manning barricades against violent protesters.

As used herein, the term “RSSI-based criterion” means an algorithm based on a beacon signal's RSSI, or sequential RSSI's, used to trigger an action in a remote device. An RSSI-based criterion is either a proximity criterion or a distance criterion.

As used herein, the term “proximity criterion” means an RSSI-based criterion that triggers some action in the remote unit upon detection of a beacon signal of sufficient measure of RSSI. The measure of RSSI may be an average of two or more sequential signal RSSIs, or some other function of beacon signal RSSI. The intention is to trigger an action upon crossing into a beacon's area of prominence.

As used herein, the term “distance criterion” means an RSSI-based criterion that triggers some action in the remote unit upon loss of detection of a beacon signal of sufficient measure of RSSI. The measure of RSSI may be an average of two or more sequential signal RSSIs, or some other function of beacon signal RSSI. The intention is to trigger an action upon exiting from a beacon's area of prominence.

In other embodiments, beacons are distributed at various access points in a building, and visitors are issued badges to be visibly worn during the course of their visit. Embedded into each badge is a remote unit that will trigger an audible alarm upon satisfaction of a proximity criterion to any one of the Beacons, thus enforcing security in a flexible manner, as Beacon locations may change.

In some embodiments, the Beacon-based system is designed to avoid injury to a person or a pet from impact with a moving object. Thus, in some embodiments, a Beacon is positioned into a blind spot of a vehicle, perhaps the rear, and pets and children are fitted with remote units. Each remote unit is equipped with a transceiver, microcontroller and power source. Upon satisfaction of a proximity criterion of a signal from the Beacon, the remote unit's microcontroller immediately issues a its own Stop Signal through the transceiver. The Beacon is similarly equipped with a transceiver. In some embodiments, upon receipt of the Stop Signal from the remote unit, the Beacon issues an audio alarm or a visual message to the vehicle operator. In some embodiments, the Beacon is integrated with the control system of the vehicle and, receipt of the Stop Signal from the remote unit causes the vehicle to automatically apply the brakes in a controlled manner. The result would be the avoidance of inadvertent injury to children or pets that occurs when an operator of a vehicle (e.g., a car, an SUV, a school bus) move the vehicle through a blind spot in which the child or pet happens to be at that time.

In other embodiments, Beacons are attached to doorways of commuter trains and subways, and remote units are carried by people seeking to board the train and by passengers seeking to exit the train. The result would be the avoidance of automatic doors inadvertently closing on passengers, sometimes dragging them down the platform or even on to the tracks.

### Distributed SMGs

The structure and/or operation of any of the SMG node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the SMG controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), local and remote application program interfaces Jini, Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using standard development tools such as lex, yacc, XML, and/or the like, which allow for grammar generation and parsing functionality, which in turn may form the basis of communication messages within and between components. For example, a grammar may be arranged to recognize the tokens of an HTTP post command, e.g.:

w3c-post http://. . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., the SOAP parser) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment. The following resources may be used to provide example embodiments regarding SOAP parser implementation:

http://www.xay.com/per1/site/lib/SOAP/Parser.html

http://publib.boulder.ibm.com/infocenter/tivihelp/v2r1/index.jsp?topic=/com.ibm .IBMDI.doc/referenceguide295.htm

and other parser implementations:

http://publib.boulder.ibm.com/infocenter/tivihelp/v2r1/index.jsp?topic=/com.ibm .IBMDI.doc/referenceguide259.htm

all of which are hereby expressly incorporated by reference.

### Formatted Data Collection Devices

Some embodiments of the invention are directed to Formatted Data Collection Devices (FDCDs). As used herein, the term “Formatted Data Collection Device” shall be understood to mean any electronic device capable of receiving, storing and outputting data in a predetermined format.

In some embodiments, the data are responses to questions. The questions may be in regard to health or medical issues, or may concern a clinical trial. In some embodiments, the FDCD is equipped with a speaker or earphone and jack, and a microphone, and the questions are posed in audio. Responses are spoken by the respondent and recorded by the FDCD. The FDCD is equipped with a microcontroller, and in some embodiments, the microcontroller is loaded with a speech recognition software tool (e.g., Dragon® supplied by Nuance Communications, Burlington Mass.), enabling the response to be stored digitally in alphanumeric format. Whether stored as audio or stored as alphanumeric characters, the responses are time- and date- stamped and indexed to the questions posed. Periodically, or once after all data have been collected on to the FDCD storage, the data are down loaded to a laptop, PC, Mac, server, smart phone or any other suitable device for storage or analysis. The structure of the predetermined data formatting allows a database of responses to be built, allowing statistical analysis to be conducted, perhaps in accordance with requirements of a clinical trial. Thus, the determination of whether primary and secondary endpoints have been met in a clinical trial may be more quickly made with the implementation of this invention. In some cases, this could have an impact on the timely delivery of crucial clinical information to the medical community.

### EXAMPLES

An embodiment of an SMG-Beacon protocol is describe below. The beacon transmits a data packet that provides an SMG with a unique location/track ID. On receiving this ID, the SMG uses a preprogrammed look up table (as exemplified below in Table i) to find the corresponding memory location of the track.

| Location | Track Number | Memory location |
|---|---|---|
| PARIS | 1 | 0 × 0000 |
| PARIS | 2 | 0 × 1000 |
| PARIS | 3 | 0 × 2000 |
| PARIS | 4 | 0 × 3000 |
| LONDON | 1 | 0 × 4000 |
| LONDON | 2 | 0 × 5000 |
| LONDON | 3 | 0 × 6000 |

For example, if a unique Location “PARIS” and track “2” is received, then this is converted to memory location “oxi000” and that is loaded into playback. Similarly, if, location “LONDON” and Track “1” is received, and the same device has the track listing, then location 9x4000 will be loaded.

The interval between transmission by a beacon of each packet is user configurable but is preset to an optimal value of 1 second. Once an SMG receives a packet, the packet is parsed, the radio is deactivated and the track is played. After completion of the track, the radio is reactivated.

If the SMG is playing a track, then the radio is disabled, and thus no commands can be received from the RF part. At this point, a user is allowed to enter commands through the user interface to play or pause or stop the track. They will also be permitted to rewind, on/off and forward the track. During play, all IC components are instructed to go into their sleep function. Sleep means that each IC powers down. The radio only powers up once the track has completed or there has been a user input to the guide.

If the SMG finishes playing a track and the radio part of the device then receives a message instructing the SMG to play the same track again (e.g., Location “PARIS”, track ID “5”), the receiver will ignore this command as the track has just finished playing. If, however, the user then goes to a new location track either by pushing the play next track button or by receiving the radio command, then the next time Location “PARIS” ID “5” is received from the radio, then that track will be replayed. In other words, whichever track has finished playing (either from RF or from buttons) this track will not play again from the RF part, until a different track has finished playing.

If two beacons are to be located in the same area, the protocol compares RSSI values from both transmitters. This involves using an averaging algorithm implemented over two receive cycles which allows the client to select the message with the strongest signal. RSSI can be a strong indicator in distinguishing the difference in distance when signals from two or more RF transmitters are received.

The Triggering Data Packet comprises four subpackets: an 8-bit Packet-Type subpacket, reserved for designating different types of triggers (e.g., track play, track stop, broadcast, targeted transmission); a 64-bit Location Identifier subpacket; an 8-bit Track Number subpacket; and, a 16-bit CRC subpacket. The total packet size is 12 bytes.

The beacon comprises a Texas Instruments MSP430 16-bit microcontroller (which is an ultra-low power RISC mixed signal microprocessor) and a Chipcon CC 1101 sub-iGHz front end transceiver (which features low current consumption and supports flexible data rates and modulation formats). An 868 MHz compliant antenna allows the radio to transmit at 868 MHz. A >16-bit DAC is used to process the 16 bit audio files. A 1008 A power regulator is used to accommodate current draws of up to 100 mA.

The microcontroller loops through a program repeatedly, forwarding its associated unique identifier to the transceiver for broadcasting. During this loop, the processor and radio power down for a period of one second after transmitting each packet. The power-down interval is configurable and will require optimisation at each installation site.

When initiating the radio in the beacon, the firmware will check with an internal clock as to whether the current time qualifies as a Wake Time, which is a predefined operation time window such as the time of day during which the museum is open.

In the beacon, the power output of the radio can be set in increments of 1 to 10. Signal strength, and thus range, increase with power output. The current draws of sleep mode and the ten power levels were measured and are presented in Table 2.

TABLE 2

| Power Level | Current Draw |
|---|---|
| Sleep | 10 μA |
| 1 | 11.7 mA |
| 2 | 12.4 mA |
| 3 | 13.1 mA |
| 4 | 14.3 mA |
| 5 | 16.3 mA |
| 6 | 16.4 mA |
| 7 | 19.3 mA |
| 8 | 25.4 mA |
| 9 | 29.8 mA |
| 10 | 34.2 mA |

The reliability of the beacon system was measured in the lab. Batches of 1000 packets were transmitted by the radio at frequencies of 100 milliseconds and 500 milliseconds. The results are presented in Table 3 as percentages of transmitted packets that were received intact.

TABLE 3

| | Run 1 | Run 2 | Run 3 |
|---|---|---|---|
| 1000 Packets @ | 97.8 | 98.3 | 98.4 |
| 100 ms | | | |
| 1000 Packets @ | 96.5 | 98.2 | 98.3 |
| 500 ms | | | |

The data show the beacon transmission hardware and protocol result in a very high reliability of intact packets received, even at these very high transmission rates.

In order to address various issues and improve over previous works, the application is directed to SMART MEDIA GUIDE, BEACON-BASED SYSTEMS AND FORMATTED DATA COLLECTION DEVICES. The entirety of this application (including the Cover Page, Title, Headings, Field, Background, Summary, Brief Description of the Drawings, Detailed Description, Claims, Abstract, Figures, Appendices, and otherwise) shows by way of illustration various embodiments in which the claimed inventions may be practiced. The advantages and features of the application are of a representative sample of embodiments only, and are not exhaustive and/or exclusive. They are presented only to assist in understanding and teach the claimed principles. It should be understood that they are not representative of all claimed inventions. As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functional, features, logical, organizational, structural, topological, and/or other aspects of the disclosure are not to be considered limitations on the disclosure as defined by the claims or limitations on equivalents to the claims. It is to be understood that, depending on the particular needs and/or characteristics of a SMG individual and/or enterprise user, database configuration and/or relational model, data type, data transmission and/or network framework, syntax structure, and/or the like, various embodiments of the SMG, may be implemented that enable a great deal of flexibility and customization. For example, aspects of the SMG may be adapted for smart card related applications. While various embodiments and discussions of the SMG have been directed to audio guides and e-ticketing aspects, however, it is to be understood that the embodiments described herein may be readily configured and/or customized for a wide variety of other applications and/or implantations.

What is claimed is:

1. A smart media guide, comprising:
an SMG control unit comprising an SMG microprocessor;
a first SMG memory coupled to said SMG microprocessor, said first SMG
memory configured to store and allow access to original content;
an SMG transceiver configured to receive a triggering data packet transmitted by a beacon, said triggering data packet comprising a track number identification subpacket;
an SMG digital to analog converter;
an SMG user interface comprising an SMG user control interface and an SMG user output interface; and,
an SMG power supply;
wherein, said smart media guide is configured, after receiving said triggering data packet, to access a track from said original content corresponding to said track number indicated in said track number identification subpacket and to play said track through said SMG user output interface.

2. The smart media guide according to claim 1, further configured to transmit by said SMG transceiver an SMG Identifier, which comprises SMG identifying information.

3. The smart media guide according to claim 1, further configured to receive a Disablement Signal, wherein after passage of a predetermined time period since receipt of said Disablement Signal, said smart media guide will disable access to original content.

4. The smart media guide according to claim 3, further configured to receive a Re-Enablement Signal, and to then enable access to original content.

5. The smart media guide according to claim 1, wherein said smart media guide is further configured to:
receive a Transmitted Content Packet comprising Transmitted Content;
store said Transmitted Content in a second SMG memory;
determine whether a Play Criterion is satisfied; and,
if said Play Criterion is satisfied, access and play said Transmitted Content through said SMG user output interface.

6. The smart media guide according to claim 1, wherein said SMG digital to analog converter is capable of processing samples of at least 16 bits.

7. The smart media guide according to claim 1, wherein said SMG transceiver is further configured to operate at a radio frequency of between about 800 and about 928 MHz.

8. A beacon comprising:
a beacon microcontroller;
a beacon transceiver; and,
a beacon power supply,
wherein said beacon is configured to transmit at a predetermined triggering interval a triggering data packet comprising a track number identification subpacket containing a track number of a preloaded content stored on a first SMG memory.

9. The beacon according to claim 8, wherein said predetermined triggering interval is between about 0.5 and about 10 seconds.

10. The beacon according claim 8, wherein said beacon transceiver is further configured to operate at a radio frequency of between about 800 and about 928 MHz.

11. A triggered content system comprising:
a smart media guide comprising:
an SMG control unit comprising an SMG microprocessor;
a first SMG memory coupled to said SMG microprocessor, said first SMG memory configured to store and allow access to original content;
an SMG transceiver configured to receive a triggering data packet transmitted by a beacon, said triggering data packet comprising a track number identification subpacket;
an SMG digital to analog converter;
an SMG user interface comprising an SMG user control interface and an SMG user output interface;
an SMG power supply; and,
a beacon according to claim 8;
wherein:
said beacon is configured to transmit said triggering data packet comprising a track number identification subpacket containing a track number of a preloaded content stored on said first SMG memory; and,
said smart media guide is configured to receive said triggering data packet, access said track of original content from said first SMG memory and play said track through said SMG user output interface.

12. The triggered content system according to claim 11, wherein said beacon transceiver and said SMG transceiver are both further configured to operate at a radio frequency of between about 800 and about 928 MHz.

13. The triggered content system according to claim 11, wherein said beacon transceiver and said SMG transceiver are both further configured to operate via a broadcast technology selected from the group consisting of radio frequency, WiFi, Bluetooth, ultra-wideband and infrared.

14. The triggered content system according to claim 11, wherein said SMG microprocessor and said beacon microprocessor are each independently selected from the group consisting of 16-bit RISC microcontrollers comprising a clock with frequency of up to 24 MHz and an embedded non-volatile memory of at least 16 KB.

15. A widely interactive system comprising:
an exogenous source comprising a Broadcast Control Unit selected from the group consisting of a beacon, server, PC, laptop, smartphone, and mainframe computer,
wherein said exogenous source is configured to:
determine whether a Broadcast Transmission Criterion is satisfied; and,
if said Broadcast Transmission Criterion is satisfied, transmit a Transmitted Content Packet, wherein said Transmitted Content Packet comprises Transmitted Content; and,
the smart media guide according to claim 1 further configured to:
receive said Transmitted Content Packet;
store said Transmitted Content Packet in a second SMG memory;
determine whether a Play Criterion is satisfied; and,
if said Play Criterion is satisfied, access and play said Transmitted Content through said SMG user output interface.

16. The widely interactive system according to claim 15, wherein:
said Broadcast Transmission Criterion is selected from the group consisting of receipt of a Transmit Instruction transmitted from a system manager, a predetermined chronological basis and receipt of an SMG Identifer; and,
said Play Criterion is selected from the group consisting of receipt of said Transmitted Content Packet, completion of a track being played, and entry of a play command by a user through the SMG User Interface.

17. The widely interactive system according to claim 15, wherein:
said smart media guide is further configured to transmit an SMG Identifier comprising SMG identifying information; and,
said exogenous source is further configured to receive said SMG Identifier, and to read and store said SMG identifying information.

18. The widely interactive system according to claim 17, wherein said exogenous source and said SMG transceiver are both further configured to operate via a broadcast technology selected from the group consisting of radio frequency, WiFi, Bluetooth, ultra-wideband and infrared.

19. The widely interactive system according to claim 15, wherein said exogenous source and said SMG transceiver are both further configured to operate via a radio frequency of 868 MHz.

20. A method of broadcasting content to a user comprising:
determining whether a Broadcast Transmission Criterion is satisfied;
if said Broadcast Transmission Criterion is satisfied, transmitting a Transmitted Content Packet comprising content from an exogenous source;
receiving said Transmitted Content Packet by a Smart Audio Guide according to claim 1;
storing transmitted content from said Transmitted Content Packet in said Second SMG Memory;
determining whether a Play Criterion is satisfied; and,
if said Play Criterion is satisfied, accessing said content from said Second SMG Memory and playing said content through said SMG User Output interface.
